(19) United States
(12) Patent Application Publication
(10) Pub. No.: US 2009/0019067 A1
(43) Pub. Date: Jan. 15, 2009

(54) METHOD, APPARATUS, AND PROGRAM FOR INSERTING NODE

(75) Inventor: Shinji Furusho, Kanagawa (JP)

Correspondence Address: GRIFFIN & SZIPL, PC, SUITE PH-1, 2300 NINTH STREET, SOUTH, ARLINGTON, VA, 22204, US

(73) Assignee: TURBO DATA LABORATORIES INC., Kanagawa (JP)

(21) Appl. No.: 11/571,191

(22) PCT Filed: Jun. 20, 2005
(86) PCT No.: PCT/JP2005/011237

§ 371 Date: Oct. 1, 2008

(30) Foreign Application Priority Data
Jun. 23, 2004 (JP) 2004-184497

(51) Int. Cl. G06F 17/30

(52) U.S. Cl. 707/101; 707/E17.009

(57) ABSTRACT

A method for inserting a node into a tree data structure is disclosed. An information processing apparatus represents parent-child relationships between the nodes in the tree data structure by means of “child->parent” relationships, which associate node identifiers assigned to parent nodes with the node identifiers assigned to child nodes of the respective parent nodes, identifies descendant nodes of a slave-side specific node in slave-side data, and inserts the descendant nodes included in the slave-side data into master-side data as the descendant nodes of a master-side specific node in the master-side data, the master-side specific node corresponding to the slave-side specific node.

### FIELD OF THE INVENTION

The present invention relates to a method for handling a tree data structure, and, in particular, to a method for inserting a node into a tree data structure. The invention also relates to an information processing apparatus for carrying out the method. Furthermore, the invention relates to a program for executing the method and a recording medium having the program recorded thereon.

### BACKGROUND OF THE INVENTION

A database has been used in a variety of applications and a Relational Database (“RDB”), among others, has been mainly used in a medium-scale or large-scale system, because the RDB is capable of removing logical inconsistencies. For example, the RDB is used in an airline reservation system and the like. In this case, reservation targets (or mostly one target) to be identified by the system can be rapidly retrieved, or the system can confirm, cancel, or change a reservation. Furthermore, the number of vacant seats on a particular flight can be determined because the number of seats on each flight is no more than at several hundreds at most.

It is known that such RDB is suitable for handling tabular data, whereas the RDB is not suitable for handling the tree data (e.g., see non-patent document No. 1).

Furthermore, some of the applications are adapted to be represented not by the tabular data but by the tree data. In particular, XML (extended Markup Language) adopting the tree data structure as a data standard for Internet or Intranet applications has recently spread (e.g., see non-patent document No. 2 to know details about XML).

However, handling of the tree data structure, including retrieval of the tree data, is generally very inefficient. The first reason for this inefficiency is that it is difficult to locate quickly where the data should exist, as it is contained in many nodes in various places. In the RDB, for example, the data regarding “age” is stored only in the field “age”. In the tree data structure, however, since the nodes containing the data regarding “age” are located all over the place, in general, it is not possible to retrieve relevant data unless we search through the whole tree data structure.

The second reason for this inefficiency is that it takes time to represent a result of the retrieval. In the case of the tree data structure, attempting to represent a node group whose nodes meet retrieval requirements often needs to represent descendant nodes of those nodes and it takes time to represent the descendant nodes since the data structure for the tree is ad hoc unlike a RDBMS (Relational DataBase Management system).

Therefore, conventional methods have been proposed for converting tree type data into the RDB in order to take advantage of the RDB which is a main stream of the database when it is required to convert the tree data structure into the database (e.g., see patent document No. 1). In the RDB, the data is decomposed into a table (tabular form) to be stored therein. To this end, the tree type data has to be packed into the table in order to convert the actual tree type data into the RDB. However, it is required to individually pack the data into the table and design a system depending on the data structure. Therefore, building the system based on the RDB is a very troublesome task.

In addition, a method has been proposed for converting a tree type data, in particular an XML data, into the database while keeping its data structure. In a tree type data structure, since descendant nodes are created from one node and a variety of descriptions are allowed to describe the structure, the troublesome task of designing the system can be remarkably alleviated. Accordingly, there is an increased need to treat tree structure data using a technique for handling the tree structure like the XML as a core technology.

One exemplary approach of converting XML data into the database, while keeping its data structure, consists of acquiring a copy of the data written into the tree structure and separately holding index data for retrieving the data. An example of this is the index data in terms of “age” if the field of “age” is concerned (e.g., see patent document No. 2). This provides for the ability to not only take full advantage of the XML data, in that an attribute can be added to the data itself, but also to store a relational structure of each field described by a tag.

Furthermore, an specification of an object model interface, called “DOM” (Document Object Model), for expanding an XML document in a memory in the form of a tree structure has been published (e.g., see non-patent document No. 3).

Patent Document No. 1: JP2003-248615A

Patent Document No. 2: JP2001-195406A

Non-patent Document No. 1: SEC Co., Ltd., “Karearea White Paper”, [online], [searched on Feb. 19, 2004], Internet URL:http://wwww.sec.co.jp/products/karearea/

Non-patent Document No. 2: W3C, “Extensible Markup Language (XML)) 1.0 (Third Edition)”, [online], Feb. 4, 2004, [searched on Feb. 19, 2004], Internet <URL:http://www.w3.org/TR/2004/REC-xml-20040204/>

Non-patent Document No. 3: Wyke Allen, Leupen Brad, and Rehman Sultan, XML Programming, Nikkei BP Soft Press, 2002, p. 59-84. (Japanese)

### DISCLOSURE OF THE INVENTION

### Problems to be Solved by the Invention

However, the above-mentioned approach of separately holding the index data for retrieval has a disadvantage in terms of holding large-scale data, because at least duplicated data should be held and the cost of creating indices and the storage to contain the indices are required.

It takes much time to describe the nodes even if the retrieval is actually performed and the nodes are identified using such a mechanism. Furthermore, this mechanism cannot be used for the retrieval with respect to a relationship between the nodes (for example, the retrieval of the tree that includes an ancestor node having an “age” of “60” and a descendant node having the “age” of “1”).

A fundamental problem of the above-mentioned prior art is that data pertaining to certain relationships, such as parent-child, ancestor, descendant, sibling, same generation or the like, cannot be efficiently traced since the tree type data structure is described by considering only the individual data and connecting the nodes having the data stored therein by a pointer. In other words, since the pointer has no constant value, use of the pointer is limited to specifying an address at which the data is located, so it is not possible for the pointer to describe directly the relationship between the nodes. As a result, in the conventional art, it is difficult to edit a topology of the tree data structure, in particular, to insert one or more descendant nodes of a certain node into the tree data structure. The above-mentioned DOM does not define a particular way of handling the topology of the tree data structure, but only defines an operational interface for editing the topology.

Therefore, an object of the present invention is to provide a method, an information processing apparatus, a program, and a recording medium having the program recorded thereon for effectively inserting a node into a tree data structure.

### Means for Solving the Problem

In order to achieve above object, according to the present invention, nodes from a slave-side data in the form of a tree data structure is inserted into a master-side data in the form of the tree data structure based on a parent-child relationship, wherein a relationship between the nodes in the form of a tree data structure is represented not a “parent->child” relationship, in which parent nodes are associated with child nodes, but a “child->parent” relationship, in which the child nodes are associated with the parent nodes.

Therefore, according to the present invention, a node insertion method for inserting a node from a slave-side data in the form of a tree data structure into a master-side data in the form of the tree data structure, in which nodes, including a root node, are assigned unique node identifiers, and the node identifiers assigned to non-root nodes, which are nodes other than the root node, are associated with the node identifiers assigned to parent nodes of the respective non-root nodes, thereby representing a parent-child relationship between the nodes in each of the master-side data and the slave-side data, comprises the steps of:

identifying descendant nodes of a slave-side specific node in the slave-side data; and

inserting the descendant nodes of the slave-side specific node into the master-side data, wherein the descendant nodes are regarded as descendant nodes of a master-side specific node in the master-side data, which corresponds to the slave-side specific node.

If the parent-child relationship is represented by the “parent->child” relationship well known in the art, there may be several child nodes corresponding to a single parent node, so that identifying two elements, that is to say, the parent node and the child node is required to define the parent-child relationship. In other words, even if the parent node is identified, the child node, which is in the parent-child relationship with the parent node, cannot be identified. On the contrary, if the parent-child relationship is represented by the “child->parent” relationship, as proposed in the present invention, then there is necessarily a single parent node with respect to one child node, so that the single parent node corresponding to the one child node can be directly identified by identifying the child node. Thus, the descendant nodes of the slave-side specific node can be inserted as the descendant nodes of the master-side specific node by specifying the master-side specific node in the master-side data and the slave-side specific node in the slave-side data.

According to a preferable embodiment of the invention, the parent-child relationship based on a “child->parent” representation is represented by an array containing sequential integers assigned to the nodes as their respective node identifiers such that each child node of a node of interest is assigned an integer before each node in the same generation as the node of interest is assigned the integer. Therefore, the node insertion method according to the preferable embodiment, the unique node identifiers assigned to the nodes are sequential integers, which are assigned to the nodes such that each child node of a node of interest is assigned the integer before each node in the same generation as the node of interest is assigned the integer.

The descendant nodes of the slave-side specific node in the slave-side data are determined using a contiguous area in the array representing the parent-child relationship and an array representing a new child-parent relationship is created in terms of the master-side data and the descendant nodes of the slave-side specific node. Therefore, according to a more preferable embodiment of the node insertion method of the invention, the parent-child relationship in each of the master-side data and the slave-side data is represented by an array containing the node identifiers assigned to the parent nodes of the respective non-root nodes, the node identifiers assigned to the parent nodes being associated to the node identifiers assigned to the non-root nodes in order of the node identifiers assigned to the non-root nodes. Moreover, the step of identifying the descendant nodes of the slave-side specific node in the slave-side data includes the steps of:

identifying all descendant nodes of the slave-side specific node by extracting a contiguous area from the array representing the parent-child relationship in the slave-side data, wherein the contiguous area starts at a location following the location where the node identifier assigned to the slave-side specific node is stored, and values larger than or equal to a value of the node identifier assigned to the slave-side specific node is stored in the contiguous area.

According to another preferable embodiment of the node insertion method of the invention, the step of inserting the descendant nodes of the slave-side specific node into the master-side data includes the steps of:

creating an array representing a new parent-child relationship, wherein the created array consists of a first array representing the parent-child relationship between the nodes in the master-side data and a second array representing the parent-child relationship concerning the descendant nodes of the slave-side node in the slave-side data and being inserted into the first array, by

assigning the node identifiers to the nodes in the master-side data and to the descendant nodes of the slave-side specific node in the slave-side node, wherein the node identifiers are assigned according to an order, in which the descendant nodes of the slave-side specific node are inserted at the descendant nodes of the master-side specific node and each child node of a node of interest is assigned the node identifier before each node in the same generation as the node of interest is assigned the node identifier, and associating the node identifiers assigned to the nodes with the node identifiers assigned to parent nodes of the respective nodes in order thereof.

Thus, representing the node identifiers by the sequential integers allows addresses at which the node identifiers assigned to the parent nodes of the respective node to be easily derived from the node identifiers assigned to the respective nodes. As a result, a faster process for looking up the node identifier of the parent node from that of the child parent can be achieved. In addition, if the parent-child relationship between the nodes, to which sequential numbers are assigned in a depth-first manner, is represented by the array based on the “child->parent” relationship, a good property is available in that descendant nodes of a certain node appear in a contiguous area of the array. As a result, the descendant nodes of the slave-side specific node can be identified by taking advantages of this property.

Furthermore, according to a preferable embodiment of the node insertion method of the invention, the step of creating the array representing the new parent-child relationship includes the steps of:

assigning the node identifiers to the respective nodes in the master-side data according to an order, in which each child node of a node of interest is assigned the node identifier before each node in the same generation as the node of interest is assigned the node identifier, until a master-side specific node appears, and associating the node identifiers assigned to the respective nodes in the master-side data with the node identifiers assigned to parent nodes of the respective nodes in the master-side data;

assigning the node identifier to the master-side specific node, assigning the node identifiers to the descendant nodes of the slave-side specific node according to an order, in which each child node of a node of interest is assigned the node identifier before each node in the same generation as the node of interest is assigned the node identifier, such that the descendant nodes of the slave-side specific node are regarded as descendant nodes of the master-side specific node, and associating the node identifiers assigned to the descendant nodes with the node identifiers assigned to the parent nodes of the respective descendant nodes; and

if remaining nodes exist in the master-side data, assigning the node identifiers to the remaining nodes in the master-side data according to an order, in which each child node of a node of interest is assigned the node identifier before each node in the same generation as the node of interest is assigned the node identifier, and associating the node identifiers assigned to the remaining nodes with the node identifiers assigned to the parent nodes of the respective remaining nodes.

Thus, the array representing the new parent-child relationship can be created by three processes: a process preceding an insertion point, a process at the insertion process, and a process following the insertion point.

Furthermore, according to the present invention, an information processing apparatus for carrying out the above-mentioned node insertion method is provided.

The object of the present invention is also achieved by an information processing apparatus comprising a storage means for storing a master-side data and a slave-side data in the form of a tree data structure therein. Nodes, including a root node, are assigned unique node identifiers, and the node identifiers assigned to non-root nodes, which are nodes other than the root node, are associated with the node identifiers assigned to parent nodes of the respective non-root nodes. Accordingly, a parent-child relationship between the nodes in each of the master-side data and the slave-side data stored in the storage means is represented. The information processing apparatus comprises:

a descendant node identification means for identifying descendant nodes of a slave-side specific node in the slave-side data; and

a node insertion means for inserting the descendant nodes of the slave-side specific node into the master-side data, and storing information representing a new parent-child relationship in the storage means, wherein the descendant nodes are regarded as descendant nodes of a master-side specific node in the master-side data, which corresponds to the slave-side specific node.

Furthermore, according to a preferable embodiment of the information processing apparatus of the invention, the unique node identifiers assigned to the nodes are sequential integers. The sequential integers are assigned to the nodes such that each child node of a node of interest is assigned the integer before each node in the same generation as the node of interest is assigned the integer.

According to a more preferable embodiment of the information processing apparatus of the invention, the parent-child relationship in each of the master-side data and the slave-side data is represented by an array containing the node identifiers assigned to the parent nodes of the respective non-root nodes. The node identifiers assigned to the parent nodes is associated to the node identifiers assigned to the non-root nodes in order of the node identifiers assigned to the non-root nodes. In addition, the descendant node identification means identifies all descendant nodes of the slave-side specific node by extracting a contiguous area from the array representing the parent-child relationship in the slave-side data. The contiguous area starts at a location following the location where the node identifier assigned to the slave-side specific node is stored, and values larger than or equal to a value of the node identifier assigned to the slave-side specific node is stored in the contiguous area.

According to a still preferable embodiment, the node insertion means creates an array representing a new parent-child relationship. The created array consists of a first array representing the parent-child relationship between the nodes in the master-side data and a second array representing the parent-child relationship concerning the descendant nodes of the slave-side node in the slave-side data and being inserted into the first array. This is achieved by

assigning the node identifiers to the nodes in the master-side data and to the descendant nodes of the slave-side specific node in the slave-side node, wherein the node identifiers are assigned according to an order, in which the descendant nodes of the slave-side specific node are inserted at the descendant nodes of the master-side specific node and each child node of a node of interest is assigned the node identifier before each node in the same generation as the node of interest is assigned the node identifier, and

associating the node identifiers assigned to the nodes with the node identifiers assigned to parent nodes of the respective nodes in order thereof.

According to a more preferable embodiment, the descendant node insertion means comprises:

a means for determining whether the node in the master-side data is the master-side specific node;

a means for assigning the node identifier to the node in the master-side data according to an order, in which each child node of a node of interest is assigned the node identifier before each node in the same generation as the node of interest is assigned the node identifier, and associating the node identifier assigned to the node in the master-side data with the node identifier assigned to a parent node of the node in the master-side data, if the node in the master-side data is not the master-side specific node; and

a means for assigning the node identifier to the master-side specific node, assigning the node identifiers to the descendant nodes of the slave-side specific node according to an order, in which each child node of a node of interest is assigned the node identifier before each node in the same generation as the node of interest is assigned the node identifier, such that the descendant nodes of the slave-side specific node are regarded as descendant nodes of the master-side specific node, and associating the node identifiers assigned to the descendant nodes with the node identifiers assigned to the parent nodes of the respective descendant nodes, if the node in the master-side data is the master-side specific node.

Furthermore, according to the present invention, a program executed in a computer for causing the computer to perform the steps of the above-mentioned node insertion method is provided.

Still furthermore, according to the present invention, a recording medium having the program stored thereon.

### EFFECT OF THE INVENTION

According to the present invention, since a parent-child relationship between nodes in the form of a tree data structure is described based on a “child->parent” relationship, the parent-child relationship can be defined by reserving one storage location for an individual node. Therefore, a capacity of a memory, which is accessed during handling the tree data structure, is reduced, so that a faster node insertion operation can be achieved.

In addition, according to the present invention, since a block containing descendant nodes of a slave-side specific node van be easily identified by assigning node identifiers to the nodes in a depth-first mode, the more faster node insertion operation can be achieved.

### BEST MODE FOR CARRYING OUT THE INVENTION

Embodiments of the invention will be explained below with reference to accompanying drawings.

Computer System Construction

FIG. 1 shows a block diagram illustrating the hardware structure of a computer system for handling a tree data structure according to an embodiment of the present invention. The computer system 10 has the same construction as a conventional computer system. As shown in FIG. 1, the computer system 10 comprises a CPU 10 for controlling the whole system and individual components of the system by executing a program, a Random Access Memory (“RAM”) 14 for storing working data, a Read Only Memory (“ROM”) 16 for storing the program etc., and a fixed storage medium 18, such as a hard disk drive. The computer system 10 further comprises a CD-ROM driver 20 for accessing to a CD-ROM 19, an interface (I/F) 22 provided for interfacing with the CD-ROM driver 20 or an external terminal connected to an external network (not shown), an input device such as a keyboard or a mouse, and a CRT display device 26. The CPU 12, the RAM 14, the ROM 16, an external storage device 18, the I/F 22, the input device 22 and the display device 26 are connected to each other via a bus 28.

A program for building a tree data structure on a storage device and a program for converting the tree data structure on the storage device according to this embodiment may be stored in the CD-ROM 19 and read out by the CD-ROM driver 20, or may have been previously stored in the ROM 16. The program may also be stored in a predetermined area of the external storage device 18 once it has been read out from the CD-ROM 19. Alternatively, the program may be provided from outside the system via a network (not shown), an external terminal, and the I/F 22.

An information processing apparatus according to an embodiment of the present invention may be achieved by causing the computer system 10 to execute the program for building the tree data structure on the storage device and the program for converting the tree data structure on the storage device.

Tree Data Structure

FIGS. 2A and 2B illustrate POS data as examples of tree type data, respectively. FIG. 2A is an exemplary diagram visually representing a data structure (i.e., topology) and data values of the tree type data, and FIG. 2B is an exemplary diagram of the same tree type data represented in an XML format. As can be seen from FIGS. 2A and 2B, the tree data structure is represented by a combinational path of nodes and arcs, where the combinational path starts from a root node (in this example, POS data), branches at each node, and leads to a leaf node (end point). A location where an actual value, such as a value of a “SHOP NAME” node that is equal to “FRANCE BRANCH SHOP”, is stored is specified by a pointer associated with the “SHOP NAME” node.

Since the present invention is directed to the topology of the tree data structure, the invention is primarily explained in the following description with reference to the topology of the tree data structure.

The tree data structure as described above has been conventionally represented by connecting nodes containing data to each other by means of the pointer. However, this pointer-based representation has a disadvantage in that the pointer has no certainty as to its value. More specifically, in some cases a particular node A may be stored at one address (e.g., address 100), while in other cases the same node A may be stored at the other address (e.g., address 200), so that the value of the pointer cannot be kept constant. Accordingly, the value of the pointer essentially represents only the address where the node is stored. As a result, if the nodes are linked by the pointers in accordance with a depth-first rule, for example, it will now be difficult to reconnect those nodes by the pointers in accordance with a width-first rule.

On the other hand, the inventor of the present invention has found that the topology of the tree data structure can be described by an arc list. The arc list means a list of arcs representing respective parent-child relationships between nodes. FIGS. 3A, 3B, and 3C illustrate an example of a representation format for the tree data structure using the arc list, respectively. In the example, as shown in FIGS. 3A, 3B, and 3C, the tree data structure consisting of 12 nodes, which are assigned node identifiers (IDs) such as 0, 10, 20, 30, 40, 50, 60, 70, 80, 90, 100, and 110, respectively, is illustrated. FIG. 3A shows an overall tree data structure. In FIG. 3A, a number depicted in a center of a graphic symbol, such as circular shape and heart shape, denote the node ID, and a pair of the numbers enclosed in parentheses, such as <0, 10>, denote the arc. It is noted that the node ID is not limited to a character string, but may be a numeric value, an integer in particular. FIG. 3B shows the arc list from parent nodes (From-ID) to child nodes (To-ID), and FIG. 3C shows a node list formed by a list of a pair of the node ID and a node Type. It is also noted that the node list can be dispensed with if it is sufficient to represent the tree data structure. In principle, using the thus defined arc list enables the relationship between nodes to be directly described without using the pointers.

Expression Based on “Child->Parent” Relationship

In the example, as shown in FIGS. 3A to 3C, the arc list is described based on a “parent->child” relationship that associates the parent node with the child node. Since one parent node, for example, the root node 0 has three child nodes: 10, 60, and 80, the identical node IDs of 0 occur three times in a From-ID column of the arc list. This means that the child node cannot be identified, even if its parent node is identified. For this reason, the arc list is formed by one array of From-ID elements and a second array of To-ID elements. If the arc list is used, a certain node occurs in both arrays (i.e., the array of From-IDs and the array of To-IDs).

On the other hand, the parent-child relationship can be described by a “child->parent” relationship. In this case, the parent-child relationship between the nodes is represented by an array including pairs of non-root nodes and their associated parent nodes, where the non-root nodes are nodes other than the root node. If the parent-child relationship is represented by such a “child->parent” relationship, an important property can be observed, which otherwise cannot be observed for the “parent->child” relationship. This property resides in the fact that a single parent node corresponding to a certain child node can be simply identified by identifying this child node, because this child node is essentially associated with only the single parent node. In other words, it is actually sufficient for the arc list to prepare only the array of the To-ID elements. As a result, the storage capacity for holding the arc list is reduced. This reduction of the storage capacity ultimately enables faster processing because it leads to a decrease in memory access times.

FIGS. 4A, 4B, and 4C illustrate an example of a representation format for a tree data structure based on a “child->parent” relationship according to one embodiment of the present invention, respectively. FIG. 4A shows an overall tree, and FIG. 4B shows an arc list based on the “child->parent” relationship. Since the arc list in FIG. 4B contains a storage area for a parent node of a root node, the parent node of the root node is conveniently set to “−”. It is noted that the storage area for the parent node of the root node may be removed from the arc list based on the “child->parent” relationship, as shown in FIG. 4C, as there are no parent nodes of the root node. In this manner, according to the embodiment of the invention, the parent-child relationship between the nodes is represented by associating the non-root nodes with the parent nodes of the respective non-root nodes, where the non-root nodes are nodes other than the root node. A topology of the tree then can be represented by tracing the list based on the “child->parent” relationship from the child node to the parent node.

According to one embodiment of the invention, a tree data structure based on such a “child->parent” relationship is built on the RAM 14 by causing the computer system 10, as shown in FIG. 1, to perform the following steps:

a node definition step 501 for assigning unique node identifiers to nodes including a root node, and

a parent-child relationship definition step 502 for associating the node identifiers, which are assigned to non-root nodes that are nodes other than the root node, with the node identifiers assigned to parent nodes of the non-root nodes, as shown in FIG. 5. Thus, the topology of the tree is represented by

initially assigning the node identifier to the node using any identification information such as a character string, a floating point number, an integer, and the like, and

then defining the parent-child relationship based on a “child->parent” representation so that it is possible to look up (examine) the node identifier for the parent node from the node identifier for the child node.

Node Identifier

According to one preferred embodiment, in the node definition step, numeric values, more preferably, sequential integers, and further more preferably, sequential integers starting from 0 or 1 are used for the node identifiers. Thus, it is possible to increase the processing speed to look up a node identifier for a parent node using a node identifier for a child node because an address, at which the node identifier for the parent node corresponding to the child node is stored, can be easily derived from the node identifier for the child node.

In cases where the parent-child relationship between the nodes is represented by assigning sequential numbers to the nodes in the tree data structure as the node identifiers, it is advantageous that further handling of the tree data structure is facilitated by defining a numbering rule that describes an order by which the sequential numbers are assigned to the nodes. According to the present invention, for a certain node, a depth-first mode and a width-first mode are employed for the numbering rule, wherein the depth-first mode indicates a mode where the child nodes of the node of interest is assigned a number before the node in the same generation as the node of interest is assigned the number and the width-first mode indicates a mode where the node in the same generation as the node of interest is assigned the number before the child node of the node of interest is assigned the number are employed.

FIGS. 6A, 6B, and 6C illustrate a process of converting a tree structure data represented by IDs into a tree structure data represented by sequential integers according to one embodiment of the present invention. FIG. 6A illustrates the tree structure data, in which nodes are assigned their respective ID numbers, FIG. 6B illustrates a conversion rule, and FIG. 6C illustrates the tree structure data, in which the nodes are assigned their respective sequential integers. In the conversion rule of this embodiment, sequential numbers are assigned to the nodes based on a depth-first strategy. Moreover, in particular, if there are several child nodes, a minimum number is assigned to a first child (oldest sibling) node, a large number is assigned to a last child (youngest sibling) node, and the child nodes are assigned the respective numbers before the sibling nodes are assigned the numbers. Although, in this embodiment, numbering is performed in ascending order, it may be performed in descending order.

FIGS. 7A, 7B, and 7C illustrate a process of converting a tree structure data represented by IDs into a tree structure data represented by sequential integers according to one embodiment of the present invention. FIG. 7A illustrates the tree structure data, in which nodes are assigned their respective node identifiers, FIG. 7B illustrates a conversion rule, and FIG. 7C illustrates the tree data structure, in which the nodes are assigned their respective sequential integers. The conversion rule in this embodiment is a rule, which assigns sequential numbers to the nodes based on a width-first strategy. Moreover, in particular, if there are several child nodes, a minimum number is assigned to a first child (oldest sibling) node, a large number is assigned to a last child (youngest sibling) node, and the sibling nodes are assigned their respective numbers before the child nodes are assigned the numbers. Although, in this embodiment, numbering is performed in ascending order, it may be performed in descending order.

If the number is used as the node identifier in this manner, it is possible to look up an address at which a value for the node is stored using the node number directly, that is to say, in the order of O(1). In addition, the parent node can be looked up using the child node directly, that is to say, in the order of O(1), by representing a parent-child relationship as a “child->parent” relationship.

Depth-First Mode

According to one embodiment of the invention, the tree data structure based on the depth-first strategy, as shown in FIGS. 6A to 6C, is built on the storage device by causing the computer system 10, as shown in FIG. 1, to execute:

a node definition step for assigning unique sequential integers to nodes including a root node such that child nodes of a certain node are assigned their respective integers before nodes in the same generation as the certain node are assigned their respective integers, and

a parent-child relationship definition step for storing an array, which is formed by arranging the integers assigned to parent nodes of respective non-root nodes, in the storage device in order of the integers assigned to the non-root nodes, wherein the non-root nodes are nodes other than the root-node. This enables the node to be assigned the sequential number based on the depth-first strategy and the parent-child relationship between the nodes can be represented by the array describing the “child->parent” relationship.

FIG. 8 is a flowchart describing a node definition process based on the depth-first strategy according to one embodiment of the present invention. This node definition process causes the computer system 10 to execute:

a step 801 for initially assigning a number to a root node,

a step 802 for assigning the number following the number assigned to a node of interest to a child node of the node of interest if the node of interest, which has been already assigned the number, has only this child node, and

a step 803 for assigning numbers to all child nodes from a first child node to a last child node in accordance with a sibling relationship among the child nodes such that a younger sibling node is assigned the following number after all descendant nodes of an immediately older sibling node have been assigned the respective numbers, if the node of interest, which has been already assigned the number, has several child nodes. This enables the sibling relationship to be defined among the several child nodes descending from the identical parent node based on the depth-first mode.

FIG. 9 illustrates an array defining a parent-child relationship based on a “child->parent” representation generated from a tree data structure using the depth-first strategy, as shown in FIGS. 6A to 6C, according to one embodiment of the invention. As can be seen from FIG. 9, in which a subtree 1 and a subtree 2 are depicted, a good property is available in that descendant nodes of a certain node appear in a contiguous area of the array when the parent-child relationship between the nodes is represented by the array based on the “child->parent” relationship. In addition, the nodes are assigned sequential numbers using the depth-first strategy.

According to one embodiment of the invention, all descendant nodes of a certain node are identified by deriving the contiguous area, where values larger than the integer assigned to the certain node are stored, from the array using the good property of the depth-first mode. Thus, a node group representing the descendant nodes of the certain node is obtained in a form of contiguous blocks in the array. For example, assuming that a size of the contiguous blocks is m, a processing speed for identifying all descendant nodes of the certain node will be in the order of O(m).

As described above, the parent-child relationship between the nodes can be represented not only by the array describing the “child->parent” relationship, but also by an array defining a “parent->child” representation. FIG. 10 illustrates the array describing the parent-child relationship based on the “parent->child” representation generated from the tree data structure using the depth-first strategy, as shown in FIGS. 6A to 6C. Since there may exist a plurality of child nodes of a single parent node, the parent-child relationship is formed by two arrays: an array called “Aggr” to indicate an area where numbers for the child nodes of each node are stored, and an array called “P->C” to contain the numbers for the child nodes. For example, a value of an element Aggr[1], which is a second element from the top of the array Aggr, is equal to “3”, and this means that the number for the child node of a node[1] is stored at a location following an element P->C[3] of the array P->C. Thus, it is observed that the child nodes of a node[0], i.e., the root node, are 3 elements from the top of the array P->C: 1 of the P->C[0], 6 of the P->C[1], and 8 of the P->C[2], respectively.

An approach for finding an array describing a parent-child relationship based on such a “parent->child” representation will be explained hereinafter.

(1) If the number for the node is equal to a maximum suffix number (=11) for the array P->C, the node has no child nodes belonging to it. Therefore, this process is not continued.
(2) A value of the Aggr array is obtained from the number for the parent node where the number is indicated by a bold letter. This Aggr value represents a starting point of the Array P->C.
(3) The Aggr value corresponding to the parent node number plus one is obtained where the parent node number is indicated by the bold letter. The Aggr value minus one indicates an ending point of the Array P->C.

For example, the starting point of the child node of the node 0 is Aggr[0]=0 and the ending point is Aggr[1]−1, that is to say, 3−1=2. Therefore, the child nodes of the node 0 are the first, second, and third elements of the array P->C, that is to say, 1, 6, and 8, respectively.

Alternatively, the parent-child relationship based on the “parent->child” representation can be represented by two arrays that are more simple: one array of the parent node numbers and the other array of the respective child node numbers. However, finding the parent-child relation ship using these arrays is not effective, because a search of the array of the parent node numbers for the number for the parent node is required, that is to say, it takes greater time to access in the order of log(n).

Width-First Mode

According to one embodiment of the present invention, the tree data structure based on the width-first strategy, as shown in FIGS. 7A to 7C, is built on the storage device by causing the computer system 10, as shown in FIG. 1, to execute the following steps:

a node definition step for assigning unique sequential integers to nodes including a root node, such that nodes in the same generation as a certain node are assigned their respective integers before child nodes of the certain node are assigned their respective integers, and

a parent-child relationship definition step for storing an array formed by arranging the integers assigned to parent nodes of respective non-root nodes in the storage device in order of the integers assigned to the non-root nodes, wherein the non-root nodes are nodes other than the root-node. This enables the node to be assigned the sequential number based on the width-first strategy and the parent-child relationship between the nodes to be represented by the array describing the “child->parent” relationship.

FIG. 11 is a flowchart describing a node definition process based on the width-first strategy according to one embodiment of the invention. This node definition process causes the computer system 10 to execute:

a step 1101 for calculating to what generation from the root node each node belongs and calculating a count of nodes involved in each generation,

a step 1102 for initially assigning a number to the root node, and

a step 1103 for assigning the numbers to all nodes involved in a next generation succeeding to a current generation until there are no nodes left unassigned after all nodes involved in the current generation have been assigned their respective numbers, such that the numbers are assigned to the nodes in an order, in which parent nodes of the respective nodes are assigned their numbers if the parent nodes are different to others, and unique sequential numbers immediately following a previously assigned number are assigned to the nodes including a first child node through a last child node by defining a sibling relationship among several child nodes descending from the parent node if the parent nodes are identical. This enables the sibling relationship to be defined among the several child nodes descending from the identical parent node based on the width-first mode.

FIG. 12 illustrates an array defining a parent-child relationship based on a “child->parent” representation generated from a tree data structure using the width-first strategy, as shown in FIGS. 7A to 7C, according to one embodiment of the invention. As can be seen from FIG. 12, where the parent-child relationship between the nodes, which are assigned the respective sequential numbers based on the width-first strategy, is represented by the array using a “child->parent” relationship, a good property is available in that descendant nodes of a certain node appear in a contiguous area of the array. This is because the numbers assigned to the parent node appear in the array in a certain (ascending or descending) order once the parent-child relationship between the nodes that are assigned their respective sequential numbers in the width-first mode is represented based on the “child->parent” relationship.

Therefore, according to one embodiment of the invention, all child nodes of the certain node can be identified by extracting the contiguous area, which stores the same vales as the value assigned to the certain node, from the array using this good property of the width-first model. This enables the child nodes of the certain node to be retrieved by means of, for example, a binary search method or the like, and in other words, they can be retrieved in the order of O(log(n).

As described above, the parent-child relationship between the nodes can be represented not only by the “child->parent” relationship, but also by the “parent->child” relationship. FIG. 13 illustrates an array defining a parent-child relationship based on a “parent->child” representation generated from a tree data structure using a width-first strategy, as shown in FIGS. 7A to 7C. In FIG. 13, since there may be a plurality of child nodes belonging to a single parent node, the array defining the parent-child relationship is formed by two arrays: an array Aggr indicating an area where numbers for the child nodes of each node is stored and an array P->C containing the numbers for the child nodes. For example, a value of an element Aggr[1], which is a second element from the top of the array Aggr, is equal to “3”, and this means that the number for the child node of a node[1] is stored at a location following an element P->C[3] of the array P->C. Thus it is observed that the node[0], that is to say, the child nodes of the root node are three elements from the top of the array P->C: P->C[0]=1, P->C[1]=2, and P->C[2]=3.

An approach for finding an array describing a parent-child relationship based on such a “parent->child” representation will be explained hereinafter.

(1) If the number for the node is equal to a maximum suffix number (=11) for the array P->C, the node has no child nodes belonging to it. Therefore, this process is not continued.
(2) A value of the Aggr array is obtained from the number for the parent node where the number is indicated by a bold letter. This Aggr value represents a starting point of the Array P->C.
(3) The Aggr value corresponding to the parent node number plus one is obtained where the parent node number is indicated by the bold letter. The Aggr value minus one indicates an ending point of the Array P->C.

For example, the starting point of the child node of the node 0 is Aggr[0], i.e., 0 and the ending point is Aggr[1]−1, i.e., 3−1=2. Therefore, the child nodes of the node 0 are the first, second, and third elements of the array P->C, that is to say, 1, 2, and 3.

Mutual Conversion of Representation Formats for Tree Data Structure

As mentioned above, the depth-first and width-first modes for assigning sequential numbers to nodes are provided with unique excellent properties, respectively. A computer system according to an embodiment of the invention is capable of mutually converting representation formats between a “child->parent” representation format based on a depth-depth first scheme, a “child->parent” representation format based on a width-first scheme, and a “parent->child” representation format. FIG. 14 illustrates a mutual conversion relationship between any two of the three representation formats.

FIG. 15 is a flowchart describing a method for building a tree data structure, which is carried out by a computer system, according to one embodiment of the present invention. As shown in FIG. 15, the computer system 10 builds the tree data structure on a storage device by executing a step for uniquely assigning sequentially varying integers to all nodes starting from a root node (step 1510), and a step for defining a parent-child relationship between the nodes (step 1520).

Preferably, the step 1510 for uniquely assigning the integers to the all nodes includes the steps of:

selecting one of a depth-first mode and a width-first mode in order to assign numbers to the respective nodes, wherein child nodes of a certain node are assigned their respective numbers before the nodes in the same generation as the certain node are assigned their respective numbers in the depth-first mode, and the nodes in the same generation as the certain node are assigned their respective numbers before the child nodes of the certain node are assigned their respective numbers in the width-first mode (step 1511),

retrieving the nodes using a depth-first scheme and assigning the numbers to the retrieved nodes in order of retrieval if the depth-first mode has been selected (step 1512), and

retrieving the nodes in a width-first manner and assigning the numbers to the retrieved nodes in order of retrieval if the width-first mode has been selected (step 1513). Thus, node number assignments using both of the depth-first mode and the width-first mode can be integrated in a single system, so that an appropriate representation format, if necessary, is available.

Furthermore, preferably, the step 1520 for defining the parent-child relationship between the nodes includes the steps of:

selecting either one of a child-parent representation mode and a parent-child representation mode in order to define the parent-child relationship, wherein the relationship from a child node to a parent node is defined in the child-parent representation mode and the relationship from the parent node to the child node is defined in the parent-child representation mode (step 1521),

storing the number assigned to the parent node of the child node in the storage device, in order of the numbers assigned to the child nodes, if the child-parent representation mode has been selected (step 1522), and

storing the number assigned to the child node of the parent node in the storage device, in order of the numbers assigned to the parent nodes, if the parent-child representation mode has been selected (step 1523). Thus, the parent-child relationship between the nodes represented by a “child->parent” relationship can be represented by a “parent->child” relationship, if necessary. For example, the representation based on the “parent->child” relationship is advantageous in case of information exchange with an external equipment.

In this manner, according to one embodiment of the present invention, the “child->parent” representation and the “parent->child” representation for representing the parent-child relationship, as well as, the depth-first mode and the width-first mode for assigning the numbers to the respective nodes are selectively available as the representation format for the tree data structure. A method for mutually converting different representation formats will now be briefly explained.

Conversion of Depth-First “Child->Parent” Representation into Width-First “Child->Parent” Representation

FIGS. 16A and 16B illustrate a conversion of a depth-first “child->parent” representation (FIG. 16A) into a width-first “child->parent” representation (FIG. 16B), according to one embodiment of the invention. FIG. 17 is a flowchart describing a method for converting the depth-first “child->parent” representation to the width-first “child->parent” representation. The parent-child relationship is defined by storing the number assigned to the parent node corresponding to the child node, in order of the number assigned to the child node, in the storage device of the computer system 10, e.g., the RAM 14. As shown in FIG. 17, the computer system 10 executes the steps of:

determining generation of each node in a tree data structure represented by a depth-first mode, in which child nodes of a certain node are assigned their respective numbers before the nodes in the same generation as the certain node are assigned their respective numbers, and calculating a count of nodes involved in each generation (step 1701),

determining numbers to be assigned to the nodes in each generation based on the count of the nodes involved in each generation while assigning the numbers to the nodes in a width-first mode, in which the nodes in the same generation as the certain node are assigned their respective numbers before the child nodes of the certain node are assigned their respective numbers (step 1702),

creating a conversion array converting the number assigned to each node into the number, which is assigned to the node in the width-first mode, based on the determined generation of each node and the determined numbers to be assigned in each generation (step 1703), and

converting the parent-child relationship of each node into another parent-child relationship represented by the numbers assigned to the nodes in the width-first mode using the conversion array (step 1704). Thus, it becomes possible to convert the “child->parent” representation format based on the depth-first mode into the “child->parent” representation format based on the width-first mode.

The above-mentioned process enables the conversion of the depth-first “child->parent” representation into the width-first “child->parent” representation, as shown in FIGS. 16A and 16B.

Fast Conversion of Width First “Child->Parent” Representation into Depth-First “Child->Parent” Representation

FIGS. 18A and 18B illustrate a conversion of a width-first “child->parent” representation (FIG. 18A) to a depth-first “child->parent” representation (FIG. 18B) according to one embodiment of the invention. FIG. 19 illustrates a flowchart describing a method for converting the width-first “child->parent” representation into the depth-first “child->parent” representation according to this embodiment of the invention. A parent-child relationship has been defined by storing a number, which is assigned to a parent node corresponding to a child node, in a storage device, such as the RAM 14, in the computer system 10 in order of the number assigned to the child node. As shown in FIG. 19, the computer system 10 executes the steps of:

calculating a count of descendant nodes of each node in a tree data structure represented in a width-first mode, in which nodes in the same generation as a certain node are assigned their respective numbers before child nodes of the certain node are assigned their respective numbers (step 1901),

creating a conversion array converting the number assigned to each node in the width-first mode into a number to be assigned to each node in a depth-first mode, in which the child nodes of the certain node are assigned their respective numbers before the nodes in the same generation as the certain node are assigned their respective numbers, by adding a count of preceding-sibling nodes of each node and descendant nodes of the respective preceding-sibling nodes to the number to be assigned to a parent node of each node, wherein the preceding-sibling nodes of each node are child nodes that have the same parent node as that of each node and have been assigned their respective numbers before each node is assigned its number (step 1902), and

converting the parent-child relationship of each node into a parent-child relationship represented by numbers assigned to the nodes in the depth-first mode by means of the conversion table (step 1903). Thus, it is possible to perform the fast conversion of the “child->parent” representation format based on the width-first mode into the “child->parent” representation format based on the depth-first mode, as shown in FIGS. 18A and 18B.

Conversion of Width-First “Child->Parent” Representation into Depth-First “Child->Parent” Representation

According to another embodiment of the invention, a conversion of the width-first “child->parent” representation into the depth-first “child->parent” representation can also be achieved by a conversion method using a searching technique in addition to the first conversion as described in connection with FIG. 19. A conversion method using this searching technique will now be explained.

The parent-child relationship described by the width-first “child->parent” representation has been defined by storing a number, which is assigned to a parent node corresponding to a child node, in a storage device, such as the RAM 14, in the computer system 10 in order of the number assigned to the child node. The computer system 10 executes the steps of:

retrieving, in a depth-first manner, all nodes in a tree data structure represented in a width-first mode, in which nodes in the same generation as a certain node are assigned their respective numbers before child nodes of the certain node are assigned their respective numbers, and creating a conversion array converting the number assigned to the node in the width-first mode into the number to be assigned to the node in a depth-first mode, in which the child nodes of the certain node are assigned their respective numbers before the nodes in the same generation as the certain node are assigned their respective numbers, and

converting the parent-child relationship of each node into a parent-child relationship represented by numbers assigned to the nodes in the depth-first mode by means of the conversion table.

The conversion array created by the conversion method using the searching technique is identical to that of an example created by the above-mentioned fast conversion method.

Conversion of “Child->Parent” Representation Into “Parent->Child” Representation

A conversion method for converting a “child->parent” relationship, in which a child node is associated with a parent node of the child node, into a “parent->child” relationship, in which the parent node is associated with the child node (child nodes) of the parent node, according to one embodiment of the invention will now be explained.

FIG. 20 is a flowchart describing a method for converting a “child->parent” relationship into a “parent->child” relationship according to one embodiment of the present invention. A parent-child relationship has been defined by storing a number assigned to a parent node of a child node as an element of a first array in a storage device, such as the RAM 14, in the computer system 10 in order of the number assigned to the child node. The computer system 10 executes the steps of:

calculating an occurrence count of the number assigned to each node in the first array (step 2001),

reserving a contiguous area for each node corresponding to the calculated occurrence count as a second array in the storage device in order to store the number assigned to the child node of each node (step 2002), and

reading sequentially the element from the first array and storing sequentially the number assigned to the child node of the element from the first array as an element in the second array reserved for the node, to which the number identical to a value of the element from the first array is assigned (step 2003). Thus, the parent-child relationship is converted from a “child->parent” representation format into a “parent->child” representation format. It means that the parent-child relationship after this conversion is defined by storing the number assigned to the child node of the parent node as the element of the second array in the storage device in order of the number assigned to the parent node.

In this conversion method, since properties of depth-first and width-first strategies are maintained after conversion, the “child->parent” representation based on the depth-first mode is converted into the “parent->child” representation based on the depth-first mode and the “child->parent” representation based on the width-first mode is converted into the “parent->child” relationship based on the width-first mode.

Conversion of “Parent->Child” Representation Into “Child->Parent” Representation

A conversion method for converting a “parent->child” relationship, in which a parent node is associated with a child node (child nodes) of the parent node, into a “child->parent” relationship, in which the child node is associated with the parent node, according to one embodiment of the invention, will now be explained.

FIG. 21 is a flowchart describing a conversion method of a width-first “child->parent” relationship into a depth-first “child->parent” relationship according to one embodiment of the invention. A parent-child relationship has been defined by storing a number assigned to a child node of a parent node as an element of a first array in a storage device, such as the RAM 14, in the computer system 10 in order of the number assigned to the parent node. The computer system 10 executes the steps of:

reserving a second array in the storage device in order to store the number assigned to the parent node of the child node in order of the number assigned to the child node (step 2101), and

reading sequentially the element from the first array, and storing sequentially the number assigned to the parent node of the element from the first array as an element in the second array reserved for the node, to which the number identical to a value of the element from the first array is assigned (step 2102). Thus, the parent-child relationship is converted from a “parent->child” representation format into a “child->parent” representation format. It means that the parent-child relationship after this conversion is defined by storing the number assigned to the parent node of the child node as the element of the second array in the storage device in order of the number assigned to the child node.

In this conversion method, since properties of depth-first and width-first strategies are maintained after conversion, the “parent->child” representation based on the depth-first mode is converted into the “child->parent” representation based on the depth-first mode and the “parent->child” representation based on the width-first mode is converted into the “child->parent” relationship based on the width-first mode.

Node Insertion

A “node insertion” operation editing a topology of a tree data structure will now be explained. A term, used in the context of the invention, “node insertion”, means that descendant nodes of a specific node in a slave-side data (i.e., slave-side specific node) having a tree data structure are inserted as descendant nodes of another specific node in a master-side data (i.e., master-side specific node) having the tree data structure.

FIGS. 22A, 22B, and 22C are schematic diagrams of a node insertion operation in a tree data structure according to one embodiment of the invention. FIG. 22A illustrates a master-side data in a depth-first mode, in which numbers are assigned to nodes in a depth-first manner, FIG. 22B illustrates a slave-side data in the depth-first mode, and FIG. 22C represents a result of inserting some nodes of the slave-side data into the master-side data in accordance with the depth-first mode. In particular, descendant nodes (node 2, node 3, and node 4) of node 1 in the slave-side data are inserted as the descendant nodes of a node 5 in the master-side data. Furthermore, the descendant nodes (node 6 and node 7) of a node 5 in the slave-side data are inserted as the descendant nodes of a node 9 in the master-side data. All the nodes are re-assigned their respective numbers in a depth-first manner. Since the descendant nodes are inserted at the node 5, and the inserted descendant nodes are assigned their respective numbers as node 6, node 7, and node 8, the node 6 in the master-side data is re-assigned the number of 9. In the same manner, the nodes 6, 7, 8, and 9 in the master-side data are re-assigned their numbers 9, 10, 11, and 12, respectively. Furthermore, the nodes 6 and 7 in the slave-side data are inserted at a current node 12 (corresponding to the node 9 at a point before re-assignment of the numbers) in the master-side data, and the inserted nodes are re-assigned their numbers 13 and 14, respectively. As a result, original nodes 10 and 11 in the master-side data are re-assigned their numbers 15 and 16, respectively.

In an example, as shown in FIG. 22, child nodes 6 and 7 of the node 5 in the slave-side data have been inserted at a position preceding the child nodes 10 and 11 of the node 9 in the master-side data. However, it is possible to design the position such that the nodes may be inserted between the child node 10 and the child node 11 or inserted at the position following the child nodes 10 and 11.

FIG. 23 is a flowchart describing a method for inserting a node according to one embodiment of the invention. In this method, the slave-side data represented by the tree data structure is inserted into the master-side data represented by the tree data structure.

In each of the master-side data and the slave-side data, nodes, including a root node, are assigned unique node identifiers. The node identifiers assigned to non-root nodes, which are nodes other than the root node, are associated with the node identifiers assigned to parent nodes of the respective non-root nodes, thereby representing a parent-child relationship between the nodes.

A node insertion method comprises the steps of:

identifying descendant nodes of a slave-side specific node in the slave-side data (step 2301), and

inserting the descendant nodes of the slave-side specific node into the master-side data as descendant nodes of a master-side specific node, wherein the slave-side specific node belongs to the slave-side data and the master-side specific node corresponds to the slave-side specific node (step 2302).

Thus, in the node insertion method according to one embodiment of the invention, the descendant nodes of the slave-side specific node in the slave-side data are inserted into the master-side data as the descendant nodes of a master-side specific node in the master-side data by utilizing the tree data structure described by a “child->parent” representation.

According to a preferable embodiment of the invention, the parent-child relationship between the nodes is represented by a “child->parent” representation format based on a depth-first mode, and the node identifiers are sequential integers. In this case, for example, the tree data structure, as shown in FIGS. 22A, 22B, and 22C, can be described by a “child->parent” representation format based on the depth-first mode, as shown in FIGS. 24A, 24B, and 24C. FIGS. 24A, 24B, and 24C are schematic diagrams of “child->parent” representation formats based on the depth-first mode corresponding to the data structures as shown in FIGS. 24A, 24B, and 24C, respectively.

As shown in FIGS. 24A to 24C, unique node identifiers assigned to the nodes in the master-side data and the slave-side data are sequential integers, which have been assigned to the nodes such that child nodes of a certain node are assigned their respective integers before nodes in the same generation as the certain node are assigned their respective integers. In addition, the parent-child relationship between the nodes in each of the master-side data and the slave-side data is represented by an array including the node identifier assigned to the parent node of each non-root node, wherein the node identifier in the array is associated to an order of the node identifier assigned to each non-root node. That is to say, the parent-child relationship between the nodes is represented by the “child->parent” representation format based on the depth-first mode.

In this case, the step 2301 for identifying the descendant nodes of the slave-side specific node in the slave-side data consists in identifying all of the descendant nodes of the slave-side specific node by extracting a contiguous area from the array representing the parent-child relationship concerning the slave-side data. In particular, values larger than the node identifier assigned to the slave-side specific node are stored in the contiguous area, and the contiguous area starts at a location following the location where the node identifier assigned to the slave-side specific node is stored. Identifying the descendant nodes is based on the good property in that the descendant nodes of a certain node appear in a contiguous area of an array when the parent-child relationship between the nodes, which are assigned sequential numbers in the depth-first manner, is represented by the array based on the “child->parent” relationship, as described in connection with FIG. 9.

Also, as shown in FIG. 24C, the step 2302 for inserting the descendant nodes of the slave-side specific node into the master-side data includes a step of creating an array representing a new parent-child relationship. This created array consists of a first array representing the parent-child relationship between the nodes in the master-side data and a second array representing the parent-child relationship concerning the descendant nodes of the slave-side node in the slave-side data and being inserted into the first array. Creating the array is achieved by:

(i) assigning the node identifiers to the nodes in the master-side data and assigning the node identifiers to the descendant nodes of the slave-side specific node in the slave-side node, wherein the node identifiers are assigned according to an order in which the descendant nodes of the slave-side specific node are inserted at the descendant nodes of the master-side specific node and child nodes of a certain node are assigned their respective node identifiers before the nodes in the same generation as the certain node are assigned their respective node identifiers, and

(ii) associating the node identifiers assigned to the nodes with the node identifiers assigned to parent nodes of the respective nodes in order thereof.

Thus, according to preferable one embodiment of the invention, the descendant nodes in the slave-side data are determined based on the contiguous area and the array representing the new parent-child relationship concerning the descendant nodes in the master-side data and the slave-side data is created, by taking advantages of the fact that the parent-child relationship is represented in the depth-first manner and the node identifiers are a series of integers.

In addition, the step for creating the array representing the new parent-child relationship can be achieved by the following processes: a process preceding a point of inserting descendant nodes, a process at the point of inserting the descendant nodes, and a process following the point of inserting the descendant nodes. FIG. 25 is a flowchart describing a process for creating an array representing a new parent-child relationship according to one embodiment of the invention.

As shown in FIG. 25, the step for creating the array representing the new parent-child relationship includes a processing step 2501 preceding the point of inserting the descendant nodes, a processing step 2502 at the point of inserting the descendant nodes, and a processing step 2503 following the point of inserting the descendant nodes.

STEP 2501: Nodes in the master-side data are assigned their respective node identifiers according to an order until a master-side specific node appears. The order is such that child nodes of a certain nodes are assigned their respective node identifiers before nodes in the same generation as the certain node are assigned their respective node identifiers. In addition, the node identifiers assigned to the nodes are associated with node identifiers assigned to parent nodes of the respective nodes.

STEP 2502: The master-side specific node is assigned its node identifier, and then descendant nodes of a slave-side specific node are assigned their respective node identifiers according to an order such that the descendant nodes of the slave-side specific node are regarded as the descendant nodes of the master-side specific node. The order is such that the child nodes of the certain nodes are assigned their respective node identifiers before the nodes in the same generation as the certain node are assigned their respective node identifiers. Thereafter, each descendant node that has been assigned its node identifier is associated with a node identifier of the parent node of each descendant node.

STEP 2503: If there are still remaining nodes in the master-side data, which have not been assigned their respective node identifiers, then the remaining nodes are assigned their respective node identifiers according to an order. The order is such that the child nodes of the certain nodes are assigned their respective node identifiers before the nodes in the same generation as the certain node are assigned their respective node identifiers. Thereafter, the node identifier of each of the remaining nodes is associated with a node identifier of the parent node of each remaining node.

It is assumed that descendant nodes of more than one slave-side specific node, such as a slave-side node #1 and a slave-side node #2, are to be inserted into the master-side data at a time, as an example shown in FIGS. 24A, 24B, and 24C. In this case, the step 2501 and the step 2502 may be repeatedly executed until there are no more master-side specific nodes corresponding to the slave-side specific node, and then the step 2503 may be executed.

Manipulation of Substantial Value Belonging to Node

As described above, node insertion operation for handling a topology of a tree data structure can be understood as an operation for re-assigning a node identifier (e.g., node number) to a node, which has already been assigned its node identifier. In addition to the node identifier, the node is associated with a substantial value belonging to the node, including a node type indicating a type of the node and a node value indicating a value. The node type and the node value may be identified by associating the node identifier with a pointer to a node-information storage area where information describing the node type and the node value is stored, as described in connection with FIGS. 2A and 2B.

FIG. 26 illustrates an exemplary manipulation of a substantial value belonging to a node in a node insertion process according to one embodiment of the invention. For example, in FIGS. 24A, 24B, and 24C, a node 2 in a slave-side becomes a node 6 after inserting the node 2 into a master-side as a descendant node of a node 5 in the master-side. Meanwhile, the substantial value belonging to the node 2 in the slave-side is stored in the node-information storage area located at an address “aaaa”, as shown in FIG. 26. When the node 2 in the slave-side is inserted into the master-side data, the address “aaaa” is copied to a pointer belonging to the node 6, which is created when the node is inserted. Thus, after inserting the node, the pointer pointing to the corresponding node-information storage area can be attached to the node.

Example of Node Insertion Process

A node insertion process according to one embodiment of the invention will now be explained in detail in connection an example, as shown in FIGS. 22A, 22B, and 22C. FIG. 27 is an overall schematic diagram of a node insertion process according to one embodiment of the invention. In this example, descendant nodes (node 2, node 3, and node 4) of a node 1 in a slave-side (slave-side specific node #1) are inserted into a master-side as descendant nodes of a node 5 in the master-side (master-side specific node #1). In addition, the descendant nodes (node 6 and node 7) of a node 5 in the slave-side (slave-side specific node #2) are inserted into the master-side as the descendant nodes of a node 9 in the master-side (master-side specific node #2).

The slave-side specific node and the master-side specific node, which are used for inserting the nodes, are nodes that match each other. In the following example, it is determined that the slave-side specific node and the master-side specific node match each other if a node type and a node value belonging to the slave-side specific node are identical to those belonging to the master-side specific node. In the example, as shown in FIG. 27, the node 1 in the slave-side and the node 5 in the master-side are depicted as heart shape and this means that their node types are identical. The node values belonging to those nodes, not shown in the drawing, are also identical to each other. In the same manner, the node 5 in the slave-side and the node 3 in the master-side have the same node type and node value. These slave-side specific nodes and master-side specific nodes may be previously specified by a user, or may be automatically determined based on a condition set by the user.

In FIG. 27, a tree data structures and an array describing a parent-child relationship represented by a “child->parent” representation format based on a depth-first mode are shown for each of a master-side, a slave-side, and a status after node insertion. In the tree data structure and the array describing the parent-child relationship, a variation of a node number, i.e., node identifier, is also depicted.

A node insertion process according to one embodiment of the invention consists in

matching one node in the master-side with another node in the slave-side,

determining a specific node and another specific node, which are nodes to which the node insertion process is applied, and

thereafter generating a node list, that is to say, the array describing the parent-child relationship represented by the “child->parent” representation format based on the depth-first mode.

A process for generating a node list will now be explained with reference to FIG. 28A through FIG. 35. The process for generating the node list includes a process for identifying descendant nodes, a process preceding insertion points, a first insertion process, a process preceding a second insertion point, a second insertion process, and a process following the insertion points.

FIGS. 28A to 28F illustrates a process for identifying descendant nodes according to one embodiment of the invention. As described above, a region of the descendant nodes of each slave-side specific node (i.e., a subtree) should be identified in order to perform the node insertion process. In a “child->parent” representation format based on a depth-first mode, the descendant nodes of a specific node, i.e., a vertex node, are located at a contiguous area following the vertex node. Therefore, the process for identifying the descendant nodes consists in finding the contiguous area following the vertex node. In FIGS. 28A to 28F, solid arrows are used to explain the process concerning a slave-side specific node #1 and a master-side specific node #1, and outlined arrows are used to explain the process concerning a slave-side specific node #2 and a master-side specific node #2.

In procedure 1, a check is initiated from a node 2 following a node 1, which is a vertex node (i.e., the slave-side specific node #1). A content of {2} (i.e., a parent node number associated to the node 2) is examined and found to be “1”, and “1” is a value, which is larger than or equal to a node number of the vertex node 1. Therefore, it is observed that the node 2 belongs to the vertex node [1] or VERTEX-NODE[1].

In procedure 2, the content of {3} is examined and found to be “2”, and “2” is the value larger than or equal to the vertex node 1. Therefore, it is observed that the node 3 belongs to VERTEX-NODE[1].

In procedure 3, the content of {4} is examined and found to be “1”, and “1” is the value larger than or equal to the vertex node 1, so that it is observed that the node 4 belongs to VERTEX-NODE[1].

In procedure 4, the content of {5} is examined and found to be “0”, and “0” is smaller than the vertex node 1, so that it is observed that the node 5 (and the nodes following the node 5) does not belong to vertex node [1].

Examining the vertex node 1 is completed at this point, and it is observed that an end node number for the nodes belonging to VERTEX-NODE[1] is {4}.

In procedures 5 and 6, the nodes belonging to VERTEX-NODE[5] are also examined, and it is observed that the end node number for the nodes belonging to VERTEX-NODE[5] is {7}.

Once the descendant nodes have been identified, an array describing a combination result of node lists are generated. To this end, first a conversion array recording how the node number in the master-side changes and the array describing the combination result are prepared. A size of the conversion array is the same as that of a C->P array in an original master-side. A size of the array describing the combination result can be calculated by adding a count of the descendant nodes, which are to be inserted, in the slave-side (i.e., a sum of the size of each subtree) to the size of the C->P array in the original master-side. FIG. 29 illustrates an initial status of the insertion process according to one embodiment of the invention.

Secondly, the process preceding the first insertion point is executed. FIGS. 30A, 30B, and 30C illustrate the process preceding the first insertion point according to one embodiment of the invention.

PROCEDURE 1: (1) A node 0 in a master-side is processed (FIG. 30A). Since (An address number in a C->P array in the master-side)+nIns=0+0, “0” is stored in a conversion array [0] or CONVERSION[0] (i.e., an address 0 in the conversion array), where nIns represents a count of nodes that are inserted from a slave-side. A value to be stored in the conversion array indicates to which number the node number in the master-side is renumbered by the node insertion operation. (2) Since the content of the C->P array [0] or C->P[0] (i.e., at the address 0 in the C->P array) in the master-side is “−1”, this value “−1” is directly stored in the combination result array [0] or COMBINATION-RESULT[0] (i.e., the address 0 in the combination result array). An insertion pointer for the conversion array and an insertion pointer for the combination result array are set to a beginning (i.e., address 0) in an initial status, and once the values are stored in the conversion array and the combination result array, each of the insertion pointers is advanced to the next address.

PROCEDURE 2: (1) The node 1 in the master-side is processed (FIG. 30B). Since (The address number in the C->P array in the master-side)+nIns=1+0, “1” is stored in CONVERSION[1]. (2) The content of the C->P[1] in the master-side is equal to “0” (equal to or larger than “1”). Therefore, the conversion array is referred to using this value “0” as the address to read the content of CONVERSION[0], and the content of CONVERSION[0] is stored in COMBINATION-RESULT[1].

PROCEDURE 3: The same operation as executed in PROCEDURE 2 is also continued until the insertion point, i.e., the node 5 in the master-side is reached (FIG. 30C).

FIG. 31 illustrates an insertion process at a first insertion point according to one embodiment of the invention. In procedure 4, as shown in FIG. 31, the value of nIns is incremented by a count of the nodes to be inserted, i.e., 3. Then, the node numbers (2, 3, and 4) for the respective three descendant nodes of the slave-side specific node #1 are summed by an offset value according to the following equation:

OFFSET=(INSERTION POINTER ADDRESS FOR COMBINATION-RESULT ARRAY (e.g., 6, in this example)−1)−(INSERTION START ADDRESS IN SLAVE-SIDE (e.g., 1, in this example)=4.

In addition, they are sequentially stored in corresponding COMBINATION-RESULT[6], COMBINATION-RESULT[7], and COMBINATION-RESULT[8]. It is noted that the insertion pointer address for the combination result array is fixed to “6” in calculating the offset value. In addition, the insertion start address in the slave-side is equal to the node number “1” of the slave-side specific node #1. Therefore, we can obtain:

COMBINATION-RESULT[6]=1+4=5,

COMBINATION-RESULT[7]=2+4=6, and

COMBINATION-RESULT[7]=1+4=5.

FIG. 32 illustrates a process preceding a next insertion point according to one embodiment of the invention. In procedure 5, the same operation as executed in procedure 2 is repeated until the next insertion point is reached. In particular, in terms of node 6, node 7, node 8, and node 9 in the master-side, (address number of C->P array in the master-side)+nIns=i+3 is stored in an i^{th} element of the conversion array or CONVERSION[i], where i denotes the node number in the master-side. Then, CONVERSION[j] is referred to using a content “j” of C->P[j] in the master-side as a reference address, and the content of CONVERSION[j] is stored in COMBINATION-RESULT[CONVERSION[i]]. For example, in case of i=7, 7+3, i.e., “10” is stored in CONVERSION[7], then CONVERSION[6] is referred to using the content “6” of C->P[7] as the reference address, and the content “9” of CONVERSION[6] is stored in COMBINATION-RESULT[10], because COMBINATION[CONVERSION[7]]=COMBINATION−RESULT[10].

FIG. 33 illustrates an insertion process at a second insertion point according to one embodiment of the invention. In procedure 6, as shown in FIG. 33, a value of a current nIns or “3” is incremented by the count of the nodes to be inserted, i.e., “2”, and it results in nIns=5. Then, the node numbers (6 and 7) for the respective two descendant nodes of the slave-side specific node #2 are summed by the offset value according to the following equation:

OFFSET=(INSERTION POINTER ADDRESS FOR COMBINATION-RESULT ARRAY (e.g., 13, in this example)−1)−(INSERTION START ADDRESS IN SLAVE-SIDE (e.g., 5, in this example)=7.

In addition, they are sequentially stored in corresponding COMBINATION-RESULT[13] and COMBINATION-RESULT[14]. It is noted that the insertion pointer address for the combination result array is fixed to “13” in calculating the offset value. In addition, the insertion start address in the slave-side is equal to the node number of the slave-side specific node #2. Therefore, we can obtain:

COMBINATION-RESULT[13]=5+7=12, and

COMBINATION-RESULT[14]=5+7=12.

FIG. 34 illustrates a process following an insertion point according to one embodiment of the invention. In procedure 7, the same operation as executed in procedures 2 and 5 is repeated. In particular, in terms of node 10 and node 11 in the master-side, (address number of C->P array in the master-side)+nIns=i+5 is stored in CONVERSION[i], where i denotes the node number in the master-side. Then, CONVERSION[j] is referred to using the content “j” of C->P[j] in the master-side as the reference address, and the content of CONVERSION[j] is stored in COMBINATION-RESULT[CONVERSION[i]]. For example, in case of i=10, 10+5, i.e., “15” is stored in CONVERSION[10], then CONVERSION[9] is referred to using the content “9” of C->P[10] as the reference address, and the content “12” of this CONVERSION[9] is stored in COMBINATION-RESULT[15], because COMBINATION[CONVERSION[10]]=COMBINATION_RESULT[15]. The same holds in case of i=11.

As a result of the above-mentioned process, the combination result array can be achieved, that is to say, a parent-child relationship represented by a “child->parent” representation format based on a depth-first mode in terms of a new data structure, which is generated by inserting descendant nodes of a specific node belonging to slave-side data into master-side data. FIG. 35 illustrates a result of a node insertion process according to one embodiment of the invention. In FIG. 35, there are shown a tree structure described by node numbers based on the depth-first mode and a parent-child relationship described by a corresponding “child->parent” representation based on the depth-first mode.

It is noted that one description based on the depth-first mode, which is achieved using this node insertion process, may be converted into another description based on a width-first mode, if necessary. This conversion may be accomplished by means of operations in the order of O(n), if CONVERSION OF DEPTH-FIRST “CHILD->PARENT” REPRESENTATION INTO WIDTH-FIRST “CHILD->PARENT” REPRESENTATION”, as described in connection with FIGS. 16A, 16B, and 16C, is used.

Information Processing Apparatus

FIG. 36 is a block diagram of an information processing apparatus 3600 for building a tree data structure according to one embodiment of the invention. The information processing apparatus 3600 comprises:

a storage portion 3601 for storing data representing the tree data structure,

a descendant node identification portion 3602 for identifying descendant nodes of a slave-side specific node in a slave-side data, and

a node insertion portion 3603 for inserting the descendant nodes of the slave-side specific node into the master-side data as descendant nodes of a master-side specific node, which corresponds to the slave-side specific node, in a master-side data and storing information representing a new parent-child relationship in the storage portion 3601.

According to a preferable embodiment, unique node identifiers assigned to respective nodes are sequential integers, which are assigned to the nodes such that each node in the same generation as a node of interest is assigned an integer before each child node of the node of interest is assigned the integer. In addition, in each of master-side data and slave-side data, a parent-child relationship between the nodes is represented by an array containing the node identifiers assigned to parent nodes of respective non-root nodes. In particular, the node identifiers assigned to the parent nodes are associated to the node identifiers of the respective non-root nodes in order of the node identifiers assigned to the non-root nodes.

The descendant node identification portion 3602 identifies all descendant nodes of the slave-side specific node by extracting a contiguous area from the array representing the parent-child relationship in the slave-side data. In addition, the contiguous area starts at a location following the location where the node identifier assigned to the slave-side specific node is stored, and values larger than or equal to a value of the node identifier assigned to the slave-side specific node is stored in the contiguous area.

Furthermore, the node insertion portion 3603 creates the array representing the new parent-child relationship. In addition, the created array is formed from a first array representing the parent-child relationship between the nodes in the master-side data and a second array representing the parent-child relationship concerning the descendant nodes of the slave-side node in the slave-side data and being inserted into the first array. The array is created by:

(i) assigning the node identifiers to the nodes in the master-side data and assigning the node identifiers to the descendant nodes of the slave-side specific node in the slave-side node, wherein the node identifiers are assigned according to an order, in which the descendant nodes of the slave-side specific node are inserted at the descendant nodes of the master-side specific node, and child nodes of a certain node are assigned their respective node identifiers before the nodes in the same generation as the certain node are assigned their respective node identifiers, and

(ii) associating the node identifiers assigned to the nodes with the node identifiers assigned to parent nodes of the respective nodes in order thereof.

According to a further preferable embodiment, the node insertion portion 3603 in the information processing apparatus 3600 comprises:

a node determination portion 3631 for determining whether a node of interest in the master-side data is a master-side specific node,

a non-specific node handling portion 3632 for assigning the node identifier to the node of interest in an order, in which child nodes of a certain node are assigned their respective nodes identifiers before nodes in the same generation as the certain node are assigned their respective nodes, and associating the node identifier assigned to the node of interest with the node identifier assigned to a parent node of the node of interest in order of the node identifier assigned to the node of interest, if the node in the master-side data is not the master-side specific node, and

a specific node handling portion 3633 for assigning the node identifier to the node of interest, subsequently assigning the node identifiers to descendant nodes of the slave-side specific node in an order, in which the child nodes of the certain node are assigned their respective nodes identifiers before nodes in the same generation as the certain node are assigned their respective nodes, such that the descendant nodes of the slave-side specific node are regarded as the descendant nodes of the master-side specific node, and then associating each of the descendant nodes with the node identifier assigned to the parent node of each descendant node.

The present invention is not limited to the above-mentioned embodiments, but various modifications may be made to the embodiments without departing from the scope of the invention as claimed in the appended claims and are intended to be included within the scope of the invention.

### BRIEF DESCRIPTION OF THE DRAWINGS

FIG. 1 illustrates a block diagram of a computer system handling a tree data structure according to an embodiment of the present invention.

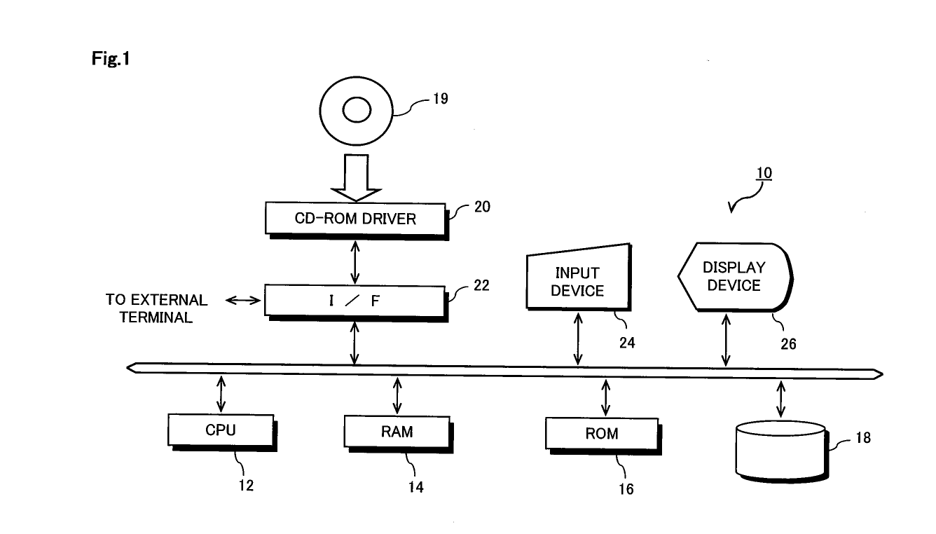

FIGS. 2A and 2B illustrate POS data as examples of tree type data, respectively, where FIG. 2A is an exemplary diagram visually representing a data structure (i.e., topology) and data values of the tree type data as well as FIG. 2B is an exemplary diagram of the same tree type data represented in an XML format.

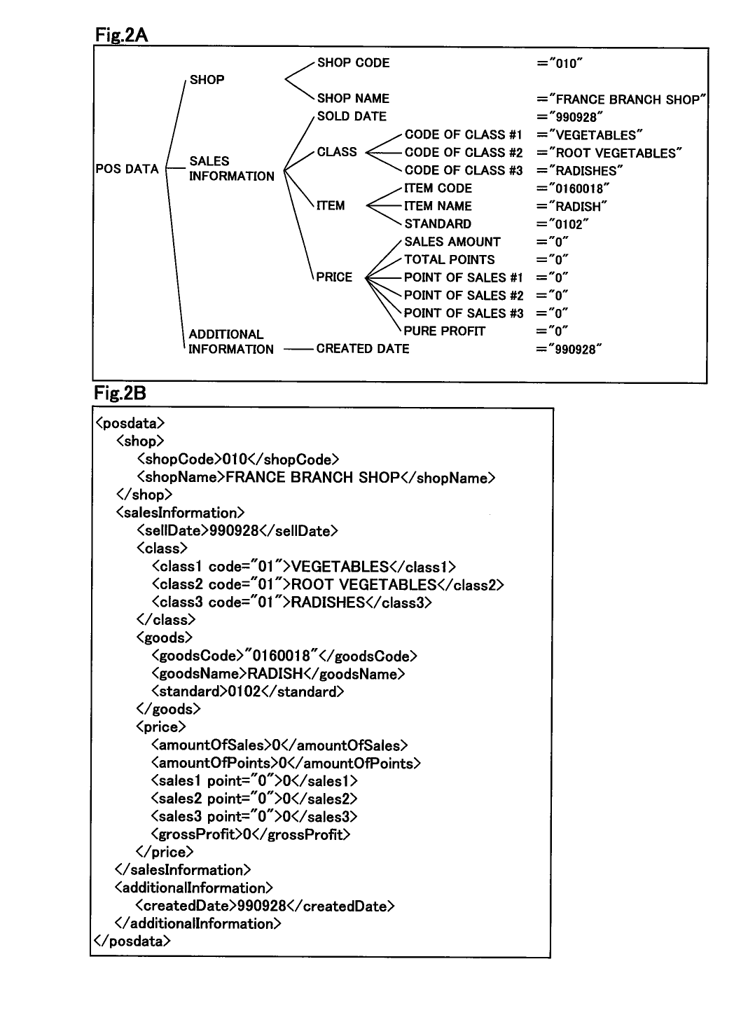

FIGS. 3A, 3B, and 3C illustrate an example of a representation format for the tree data structure using an arc list, respectively.

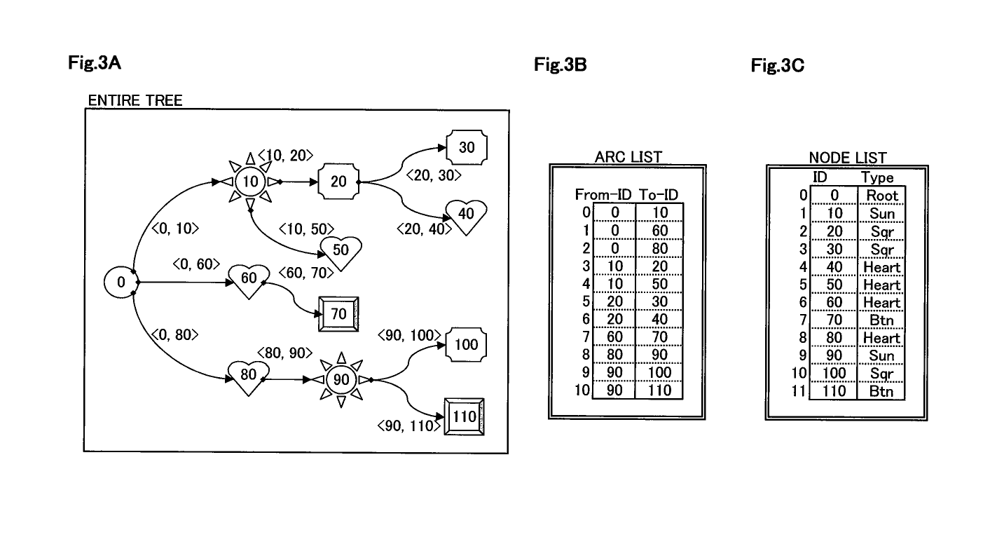

FIGS. 4A, 4B, and 4C illustrate an example of a representation format for a tree data structure based on a “child->parent” relationship according to one embodiment of the present invention, respectively.

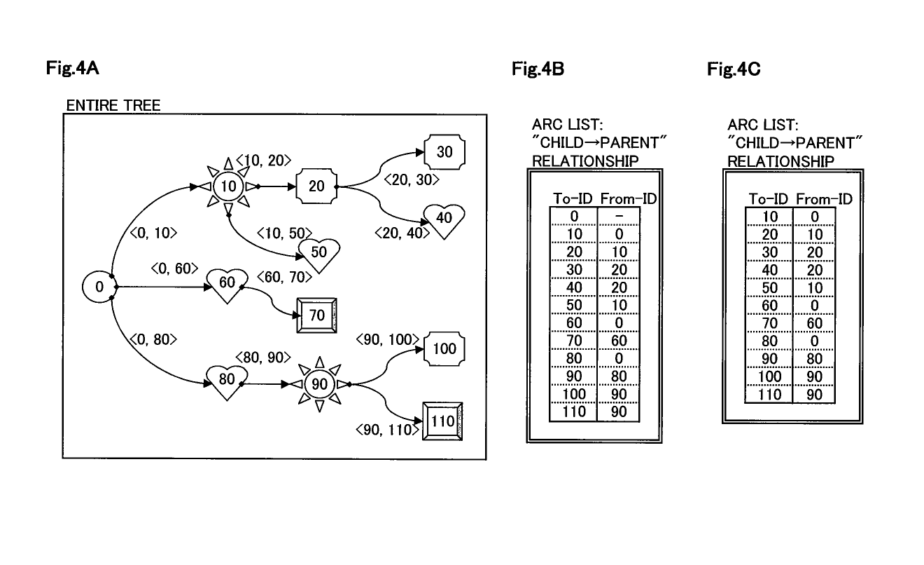

FIG. 5 is a flowchart describing a method for building a tree data structure on a storage device according to one embodiment of the present invention.

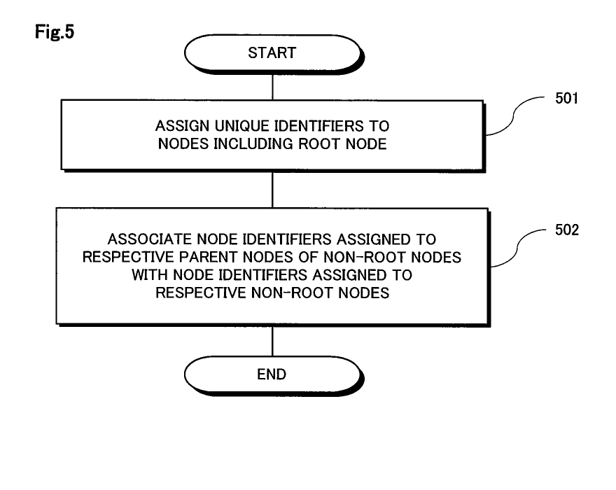

FIGS. 6A, 6B, and 6C illustrate a process for converting a tree structure data represented by IDs into a tree structure data represented by sequential integers according to one embodiment of the present invention.

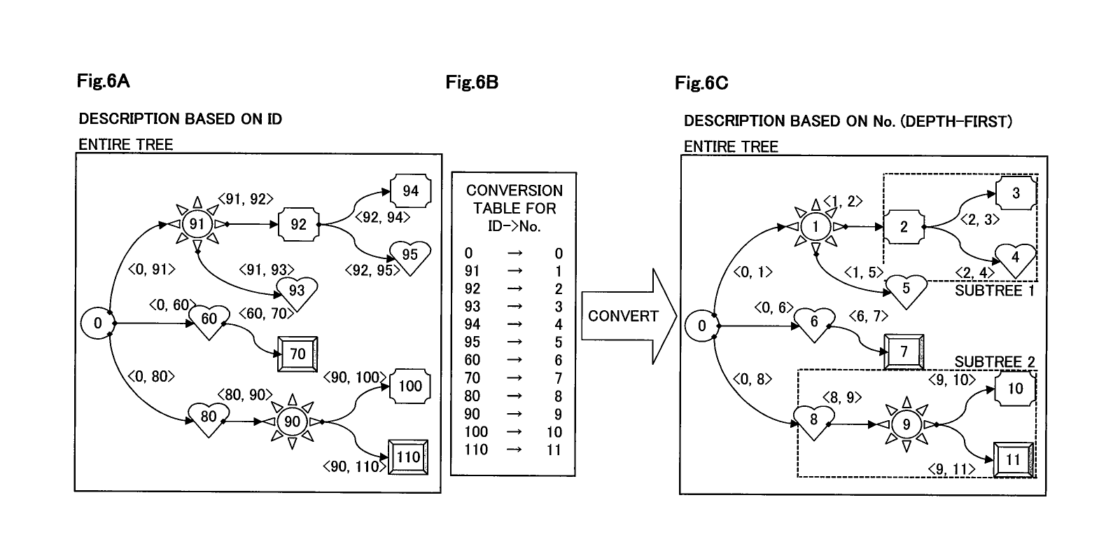

FIGS. 7A, 7B, and 7C illustrate a process for converting a tree structure data represented by IDs into a tree structure data represented by sequential integers according to another embodiment of the present invention.

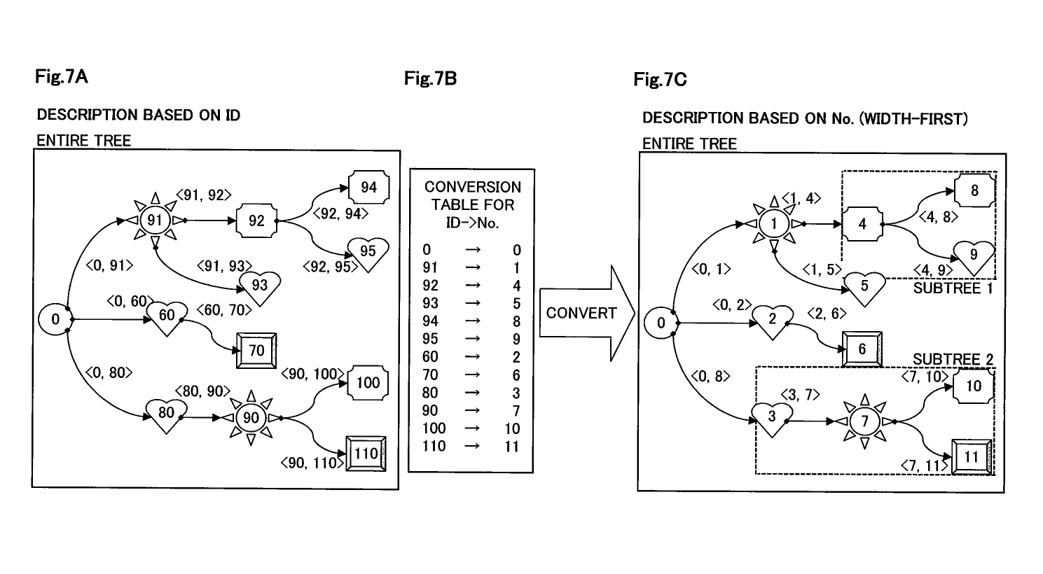

FIG. 8 is a flowchart describing a node definition process based on a depth-first strategy according to one embodiment of the present invention.

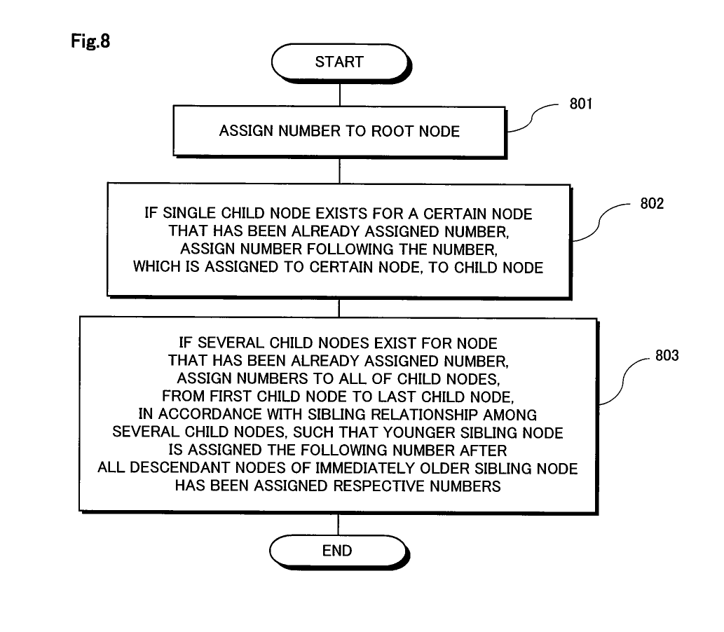

FIG. 9 illustrates an array defining a parent-child relationship based on a “child->parent” representation generated according to one embodiment of the present invention.

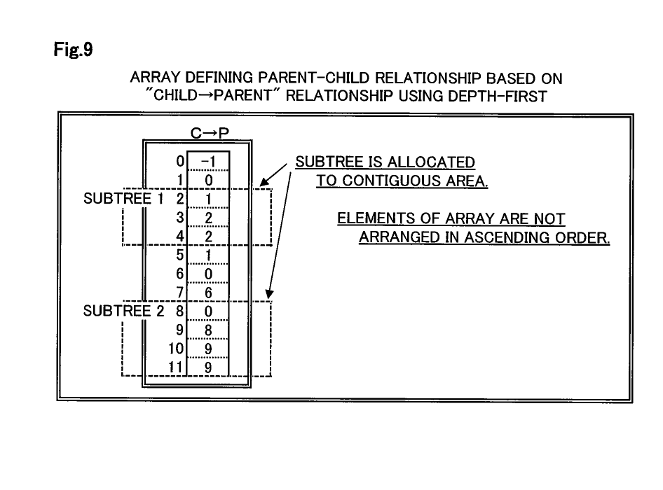

FIG. 10 illustrates an array describing a parent-child relationship based on a “parent->child” representation generated from a tree data structure using a depth-first strategy, as shown in FIG. 6.

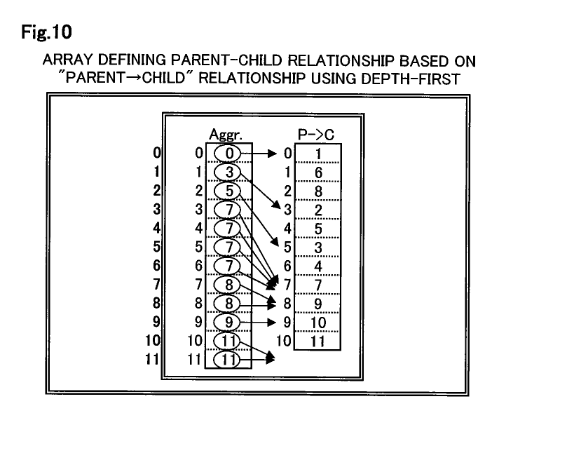

FIG. 11 is a flowchart describing a node definition process based on a width-first strategy according to one embodiment of the present invention.

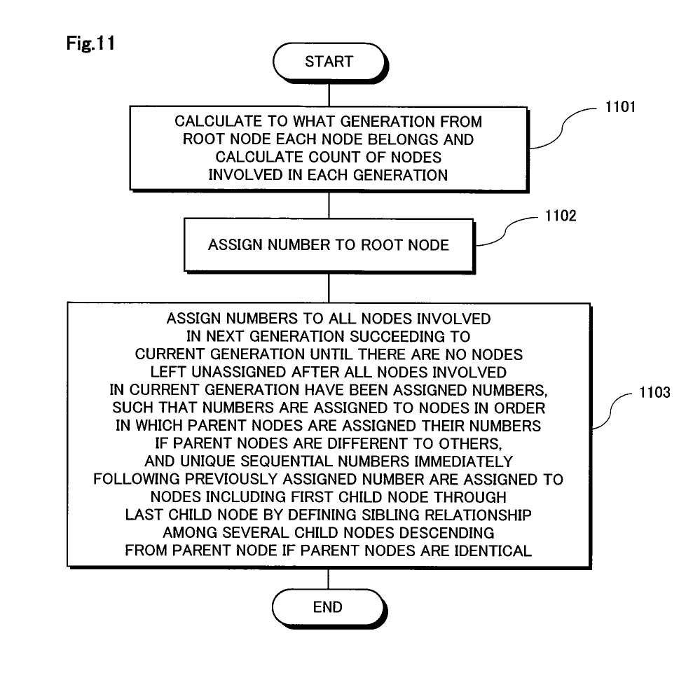

FIG. 12 illustrates an array defining a parent-child relationship based on a “child->parent” representation generated according to one embodiment of the present invention.

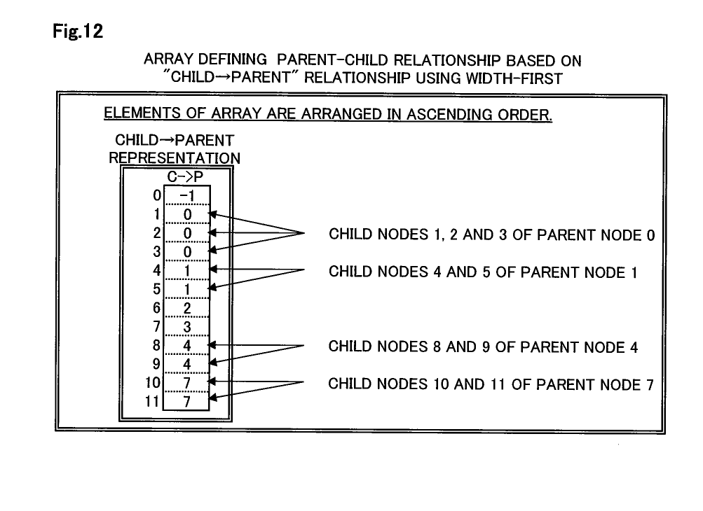

FIG. 13 illustrates an array defining a parent-child relationship based on a “parent->child” representation generated from a tree data structure using a width-first strategy, as shown in FIGS. 7a, 7b, and 7c.

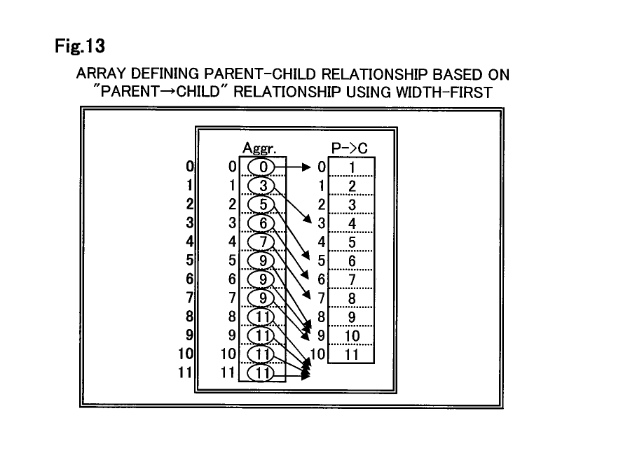

FIG. 14 illustrates a relation of mutual conversion among three representation formats according to one embodiment of the present invention.

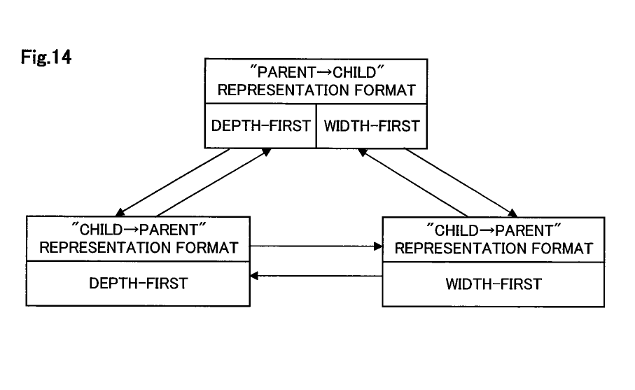

FIG. 15 is a flowchart describing a method for building a tree data structure, which is carried out by a computer system, according to one embodiment of the present invention.

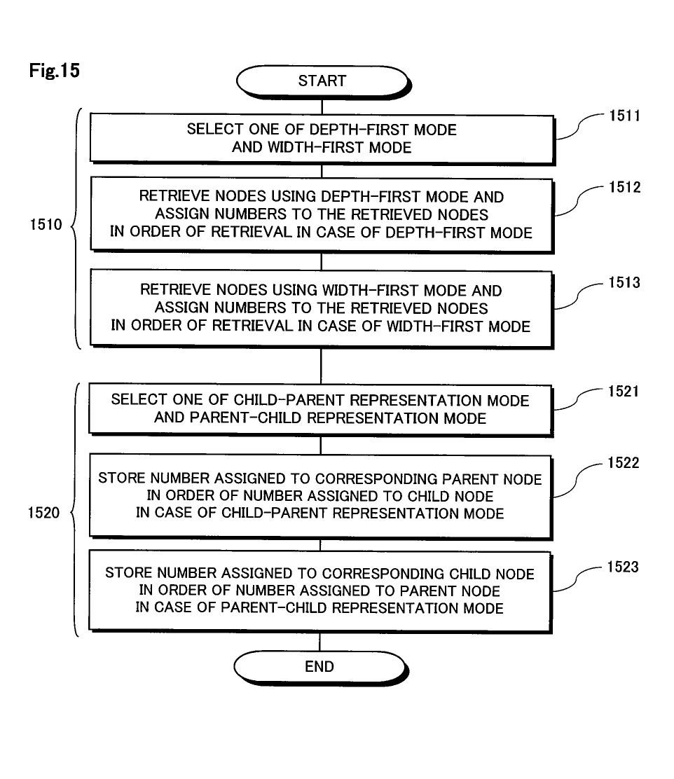

FIGS. 16A and 16B illustrates conversion from a depth-first “child->parent” representation to a width-first “child->parent” representation according to one embodiment of the present invention.

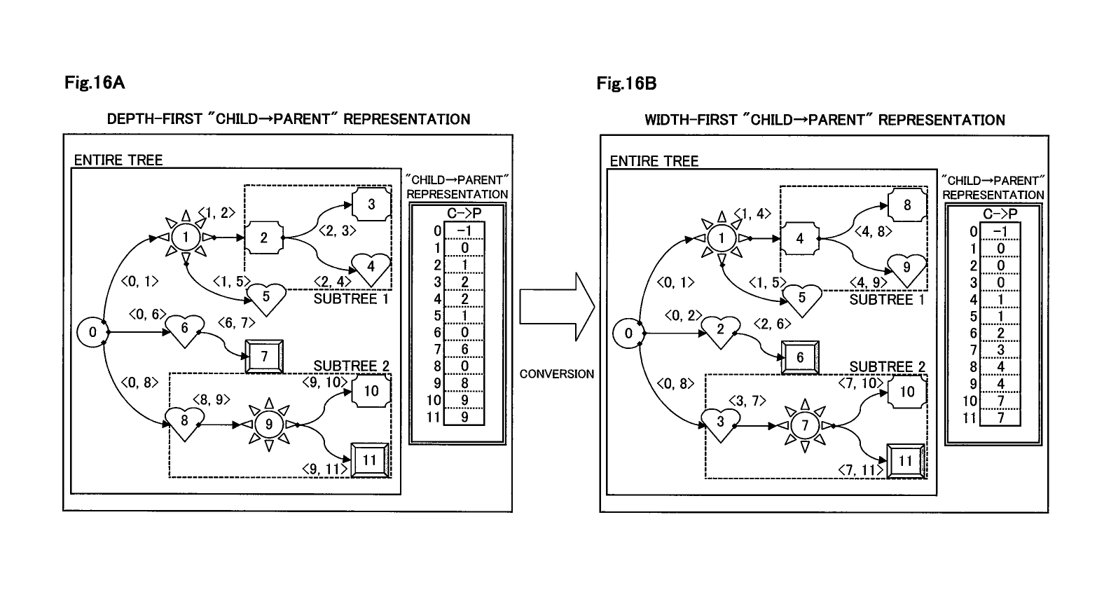

FIG. 17 is a flowchart describing a method for converting a depth-first “child->parent” representation into a width-first “child->parent” representation according to one embodiment of the present invention.

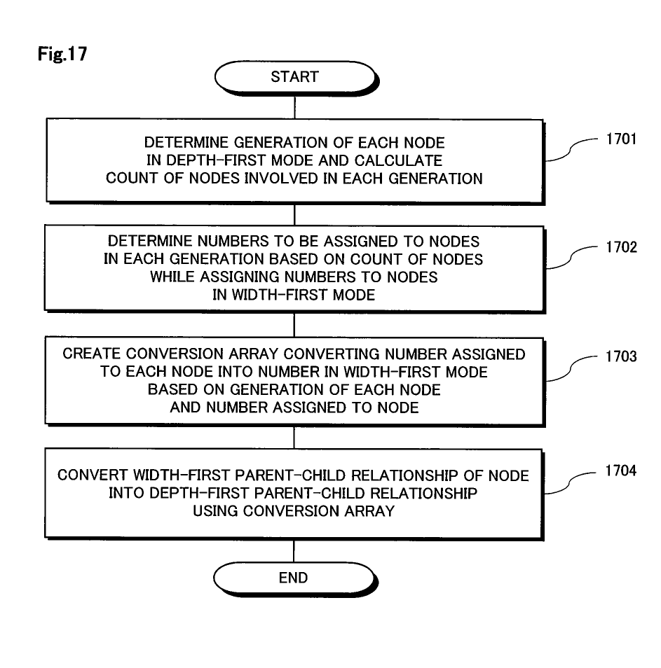

FIGS. 18A and 18B illustrate conversion of a width-first “child->parent” representation into a depth-first “child->parent” representation according to one embodiment of the present invention.

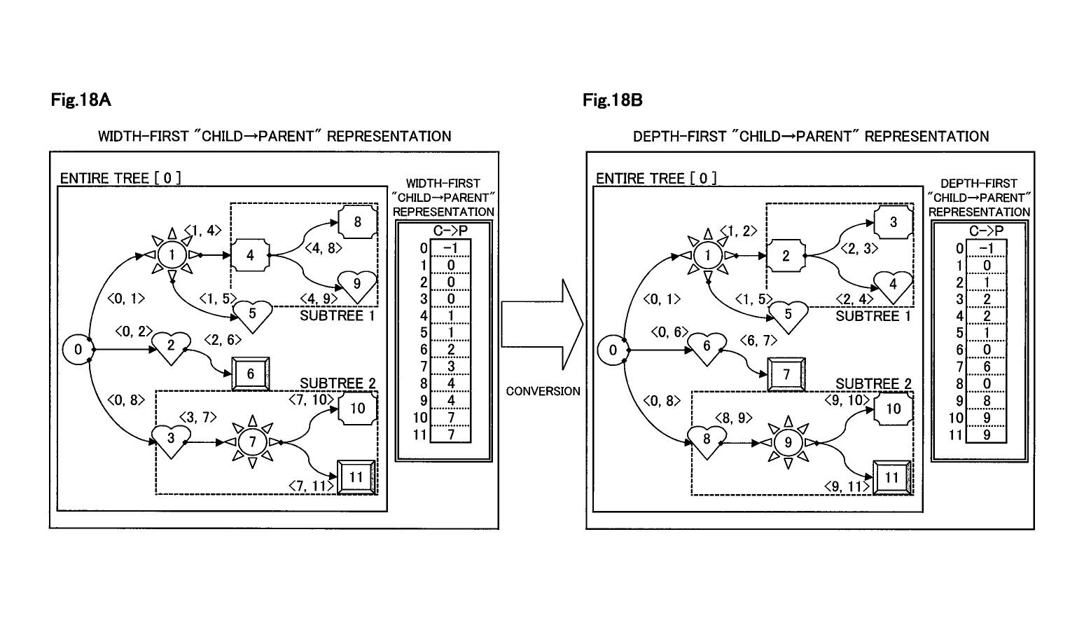

FIG. 19 illustrates a process for converting a parent-child relationship between nodes based on a width-first manner into a parent-child relationship between the nodes based on a depth-first manner according to one embodiment of the present invention.

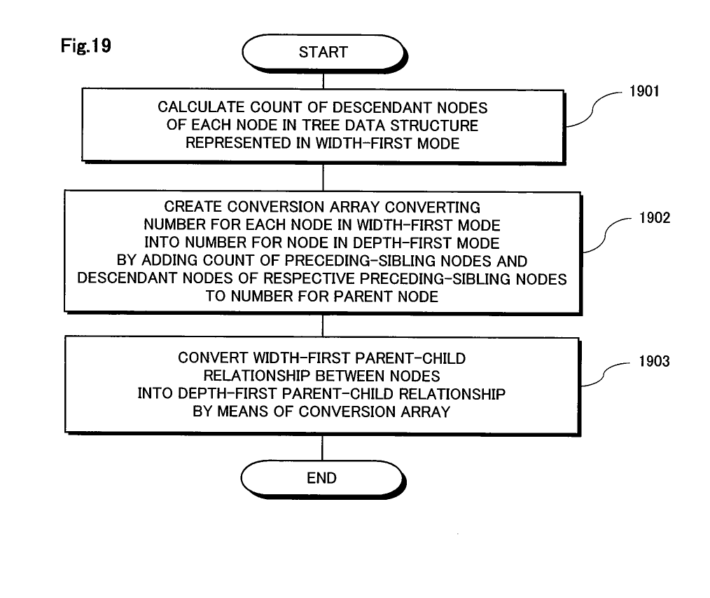

FIG. 20 illustrates a flowchart for converting a “child->parent” representation into a “parent->child” representation according to one embodiment of the present invention.

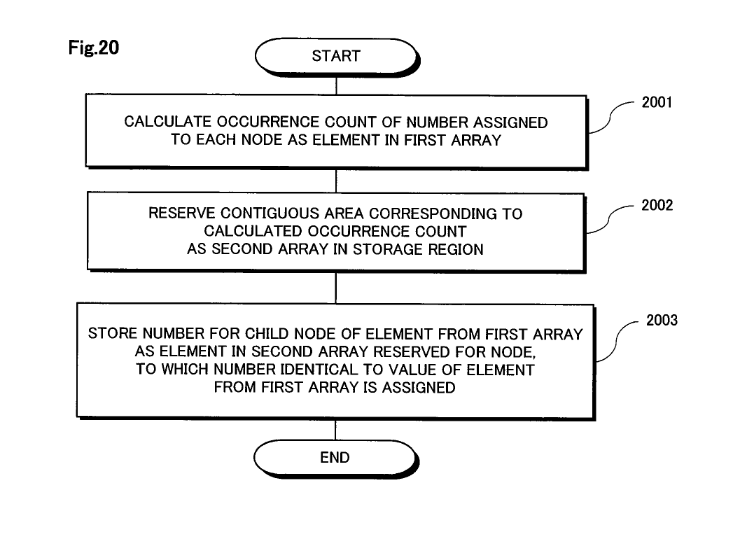

FIG. 21 is a flowchart describing a method for converting a “parent->child” representation into a “child->parent” representation according to one embodiment of the present invention.

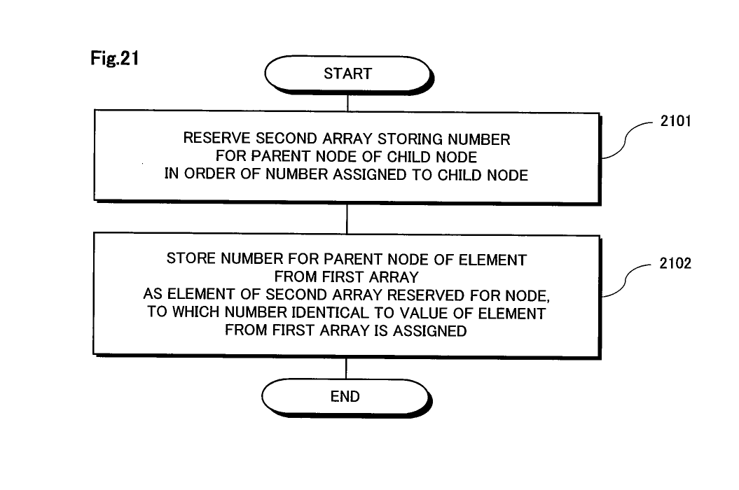

FIGS. 22A, 22B, and 22C illustrate node insertion in a tree data structure according to one embodiment of the present invention.

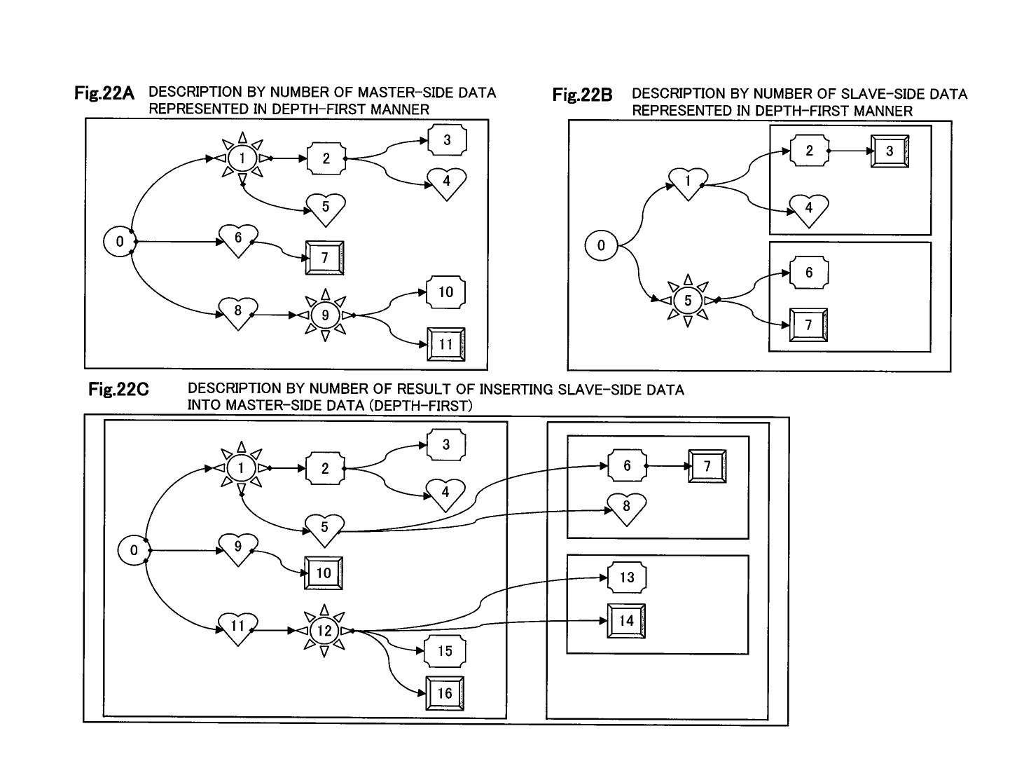

FIG. 23 is a flowchart describing a node insertion method according to one embodiment of the present invention.

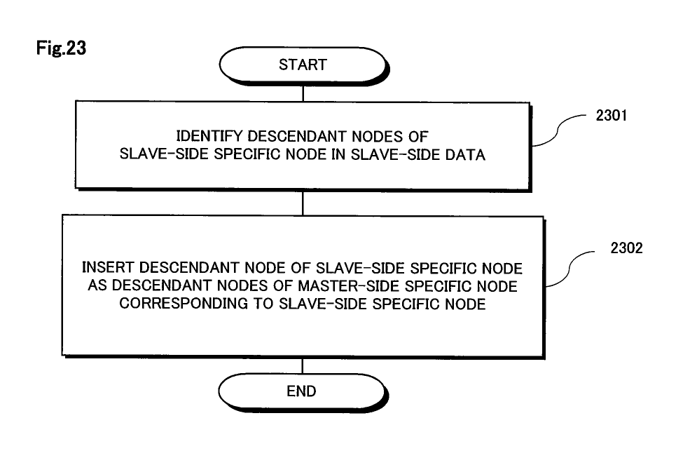

FIGS. 24A, 24B, and 24C illustrate depth-first “child->parent” representation formats corresponding to FIGS. 22A, 22B, and 22C, respectively.

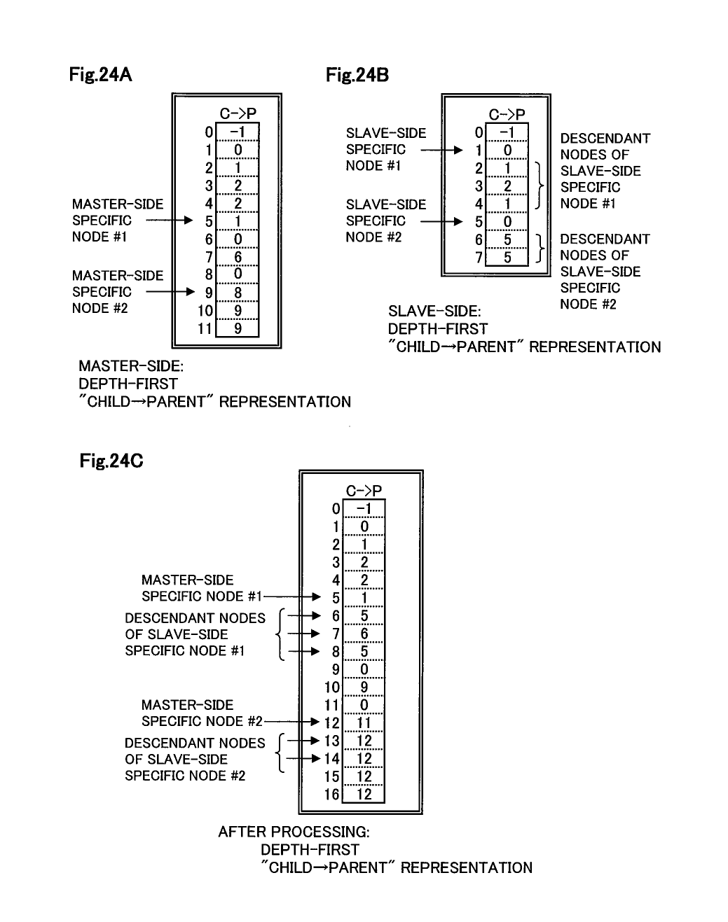

FIG. 25 is a flowchart describing a process for creating an array representing a new parent-child relationship according to one embodiment of the present invention.

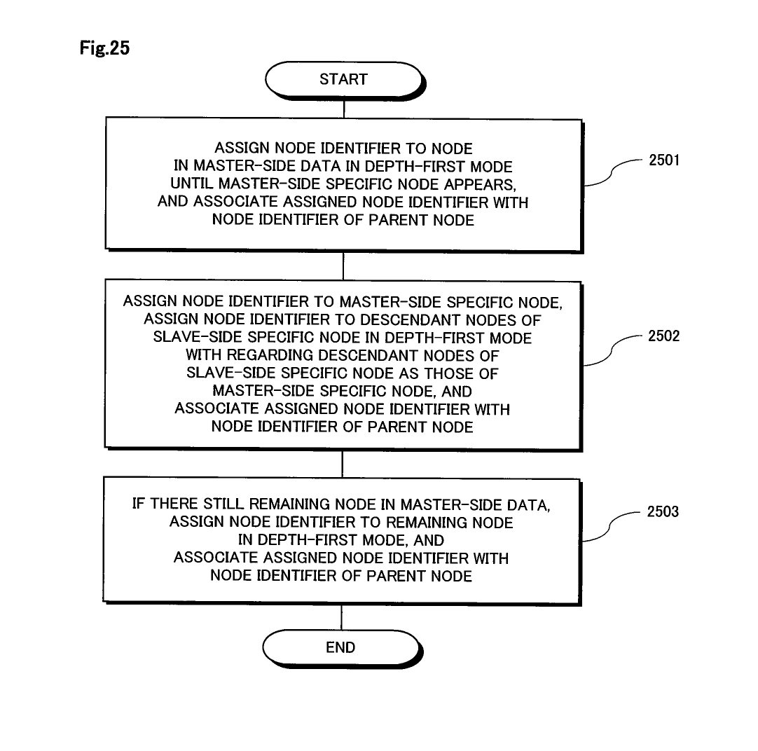

FIG. 26 illustrates an example of handling a substantial value belonging to a node in a node insertion process according to one embodiment of the present invention.

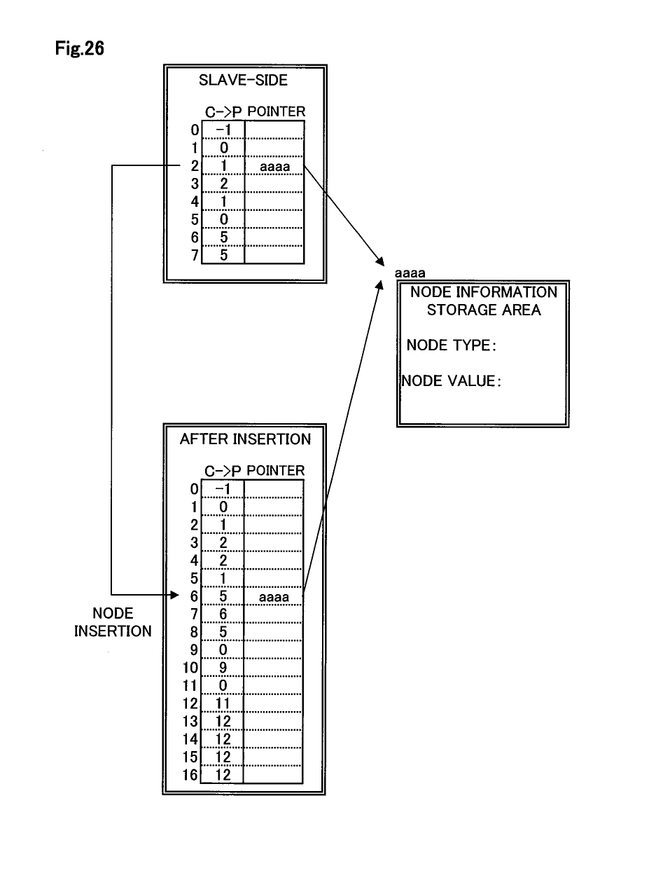

FIG. 27 is an overall schematic diagram of a node insertion process according to one embodiment of the present invention.

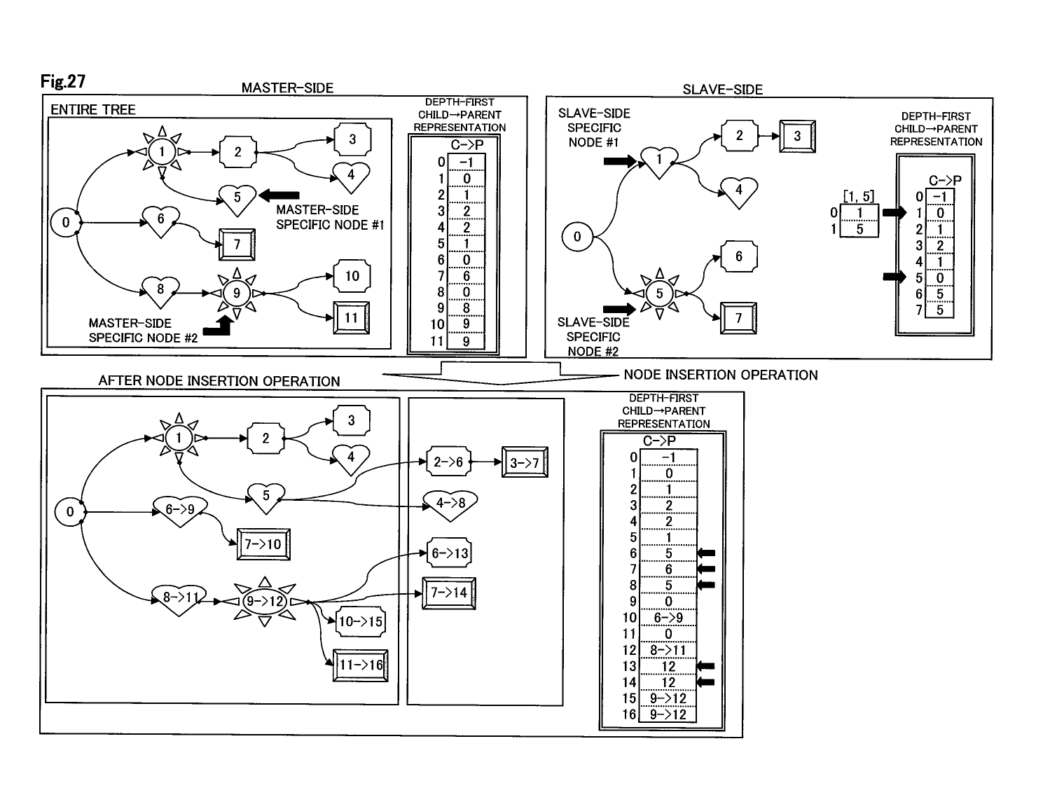

FIGS. 28A to 28F illustrate a process for identifying descendant nodes according to one embodiment of the present invention.

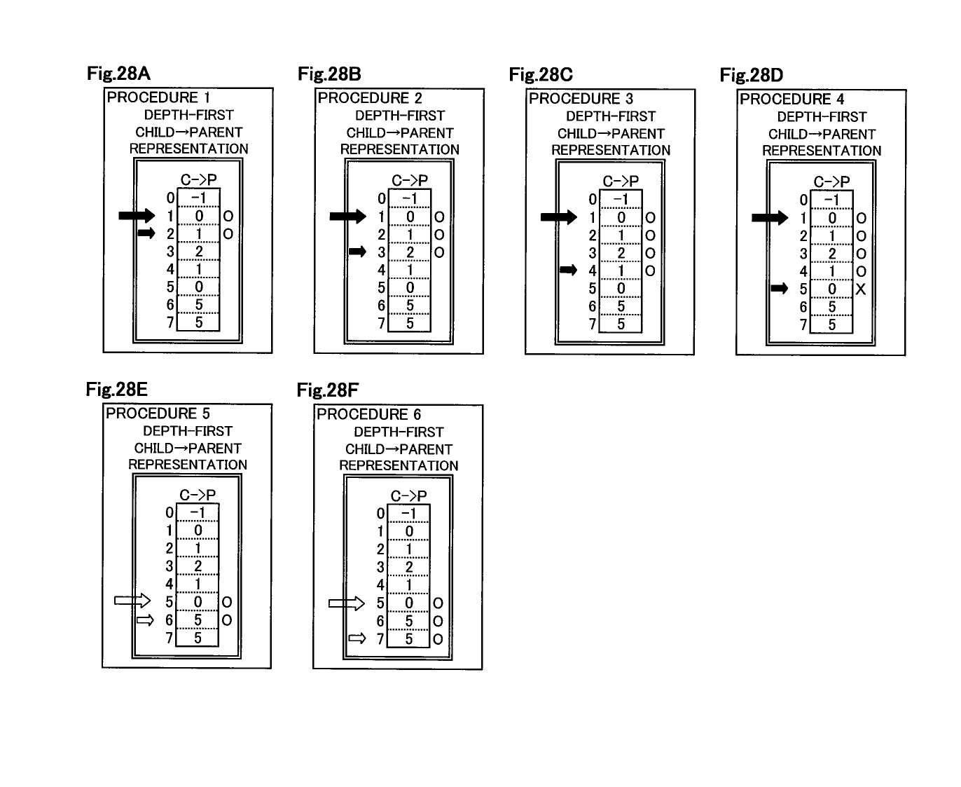

FIG. 29 illustrates an initial status in an insertion process according to one embodiment of the present invention.

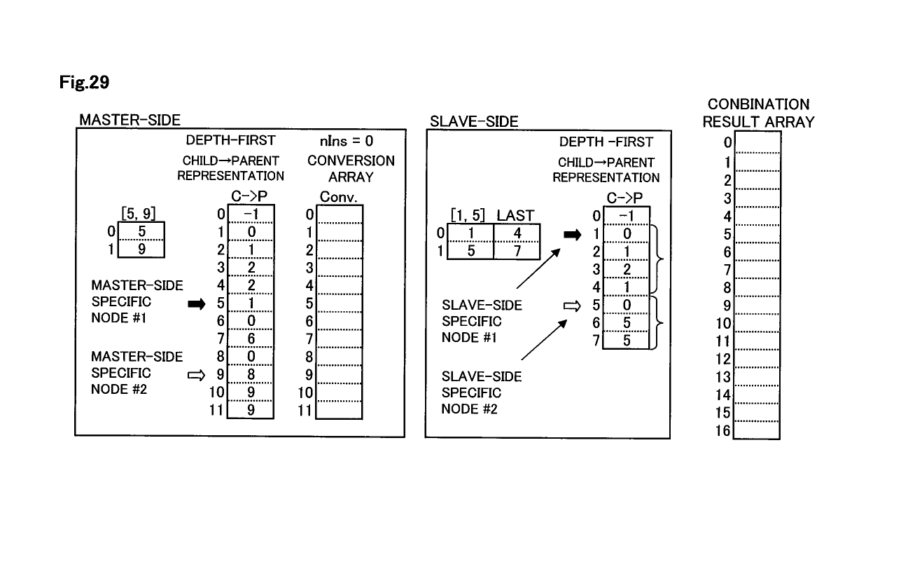

FIGS. 30A, 30B, and 30C illustrate a process preceding a first insertion point according to one embodiment of the present invention.

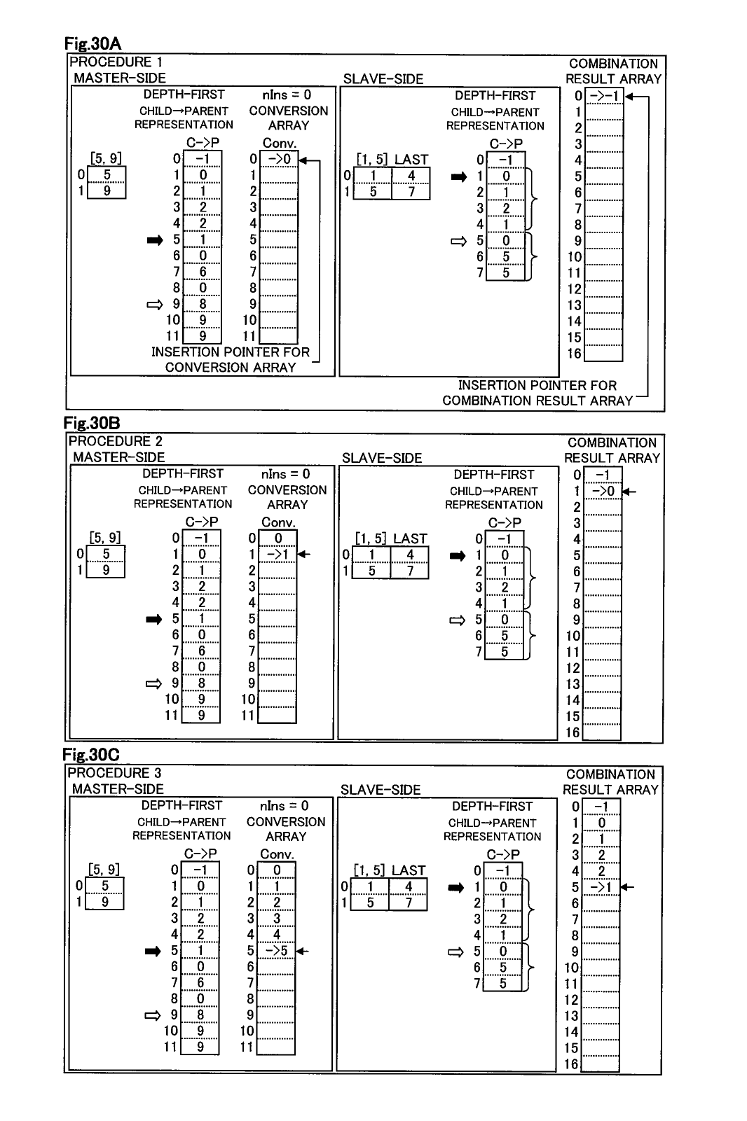

FIG. 31 illustrates an insertion process at a first insertion point according to one embodiment of the present invention.

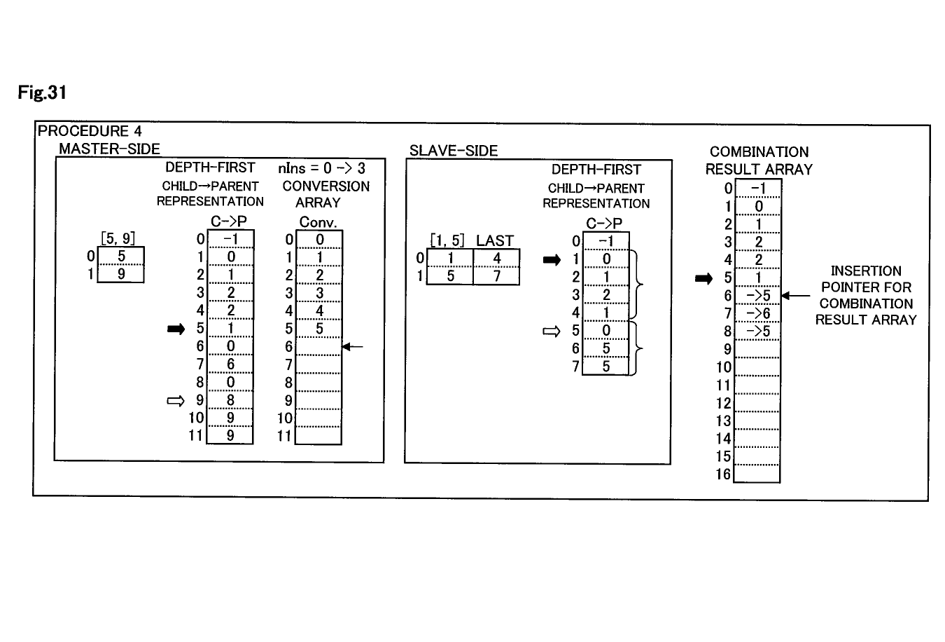

FIG. 32 illustrates a process preceding a second insertion point according to one embodiment of the present invention.

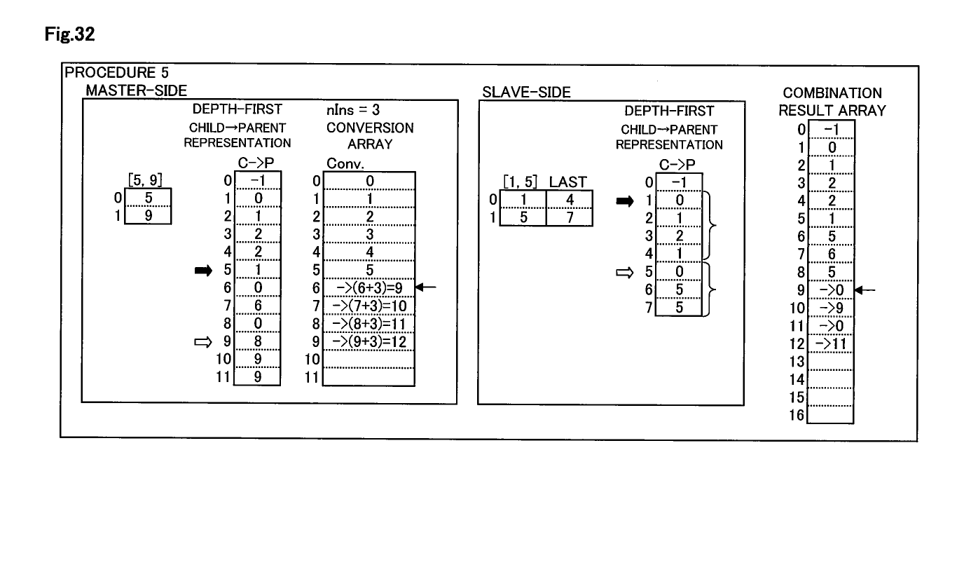

FIG. 33 illustrates an insertion process at a second insertion point according to one embodiment of the present invention.

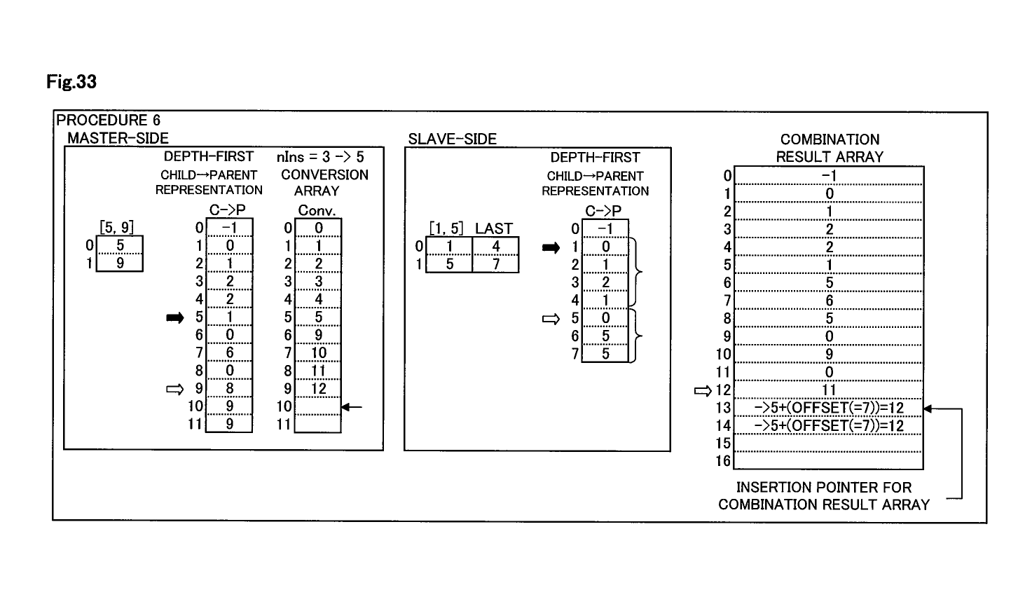

FIG. 34 illustrates a process following insertion points according to one embodiment of the present invention.

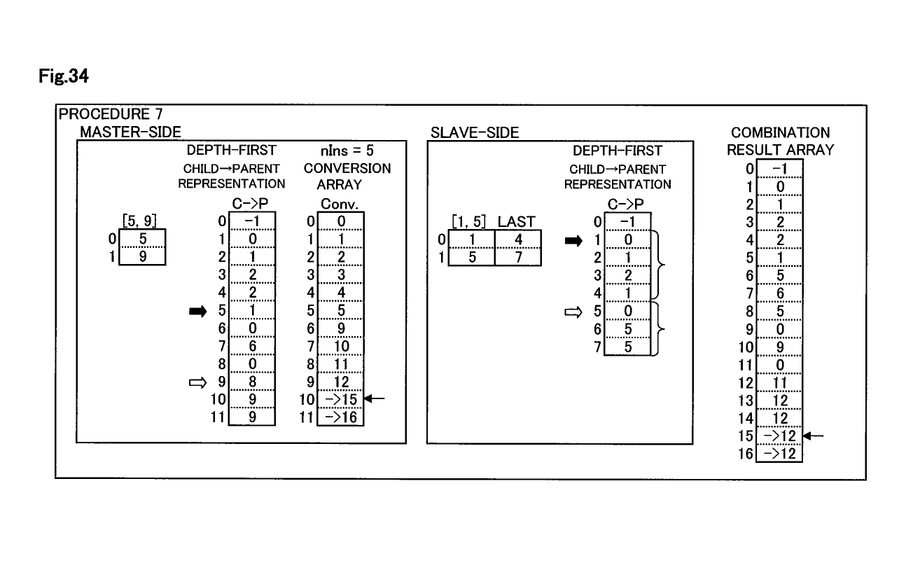

FIG. 35 illustrates a result of a node insertion process according to one embodiment of the present invention.

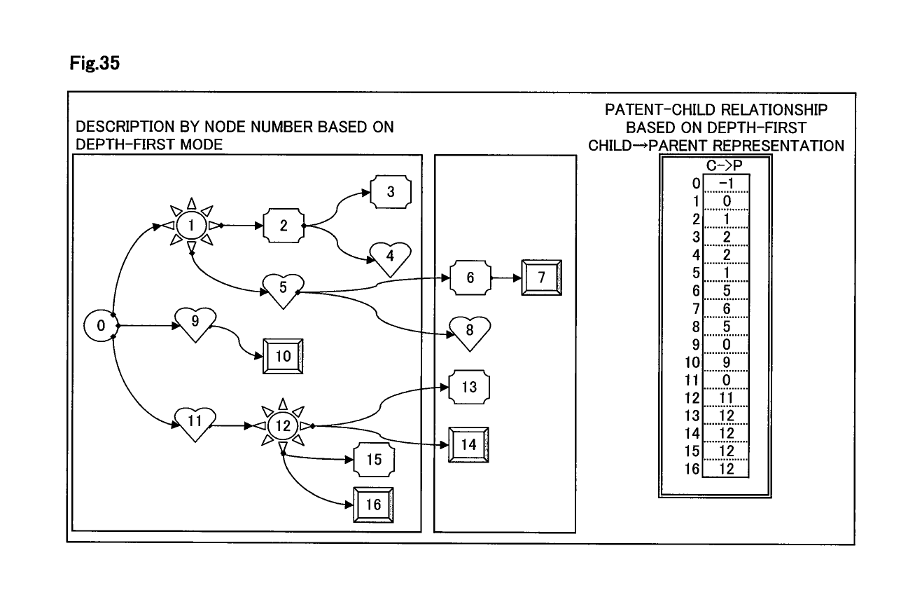

FIG. 36 is a block diagram of an information processing apparatus for performing a node insertion operation according to one embodiment of the present invention.

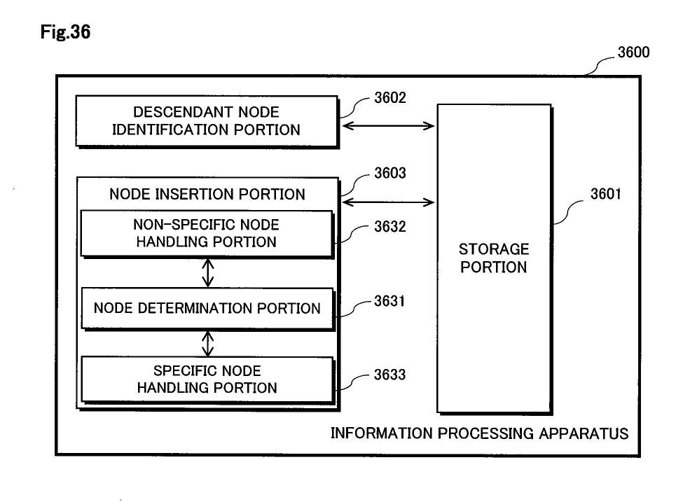

### DESCRIPTION OF THE REFERENCE NUMERALS

Computer System
12 CPU
14 RAM
16 ROM
18 Fixed Storage Device
20 CD-ROM Driver
22 I/F
24 Input Device
26 Display Device
3600 Information Processing Apparatus
3601 Storage Portion
3602 Descendant Node Identification Portion
3603 Node Insertion Portion
3631 Node Determination Portion
3632 Non-Specific Node Handling Portion
3633 Specific Node Handling Portion

1-16. (canceled)

17. A node insertion method for inserting a node from a slave-side data in the form of a tree data structure into a master-side data in the form of the tree data structure, wherein in each of the master-side data and the slave-side data,
nodes, including a root node, are assigned unique node identifiers, which are sequential integers that are assigned to the nodes such that each child node of a node of interest is assigned the integer before each node in the same generation as the node of interest is assigned the integer,
the node identifiers assigned to non-root nodes, which are nodes other than the root node, are associated with the node identifiers assigned to parent nodes of the respective non-root nodes, and
a parent-child relationship between the nodes is represented by an array containing the node identifiers assigned to the parent nodes of the respective non-root nodes, said node identifiers assigned to the parent nodes being associated to the node identifiers assigned to the non-root nodes in order of the node identifiers assigned to the non-root nodes, characterized in that the node insertion method comprises the steps of:
identifying all descendant nodes of the slave-side specific node by extracting a contiguous area from the array representing the parent-child relationship in the slave-side data, wherein the contiguous area starts at a location following the location where the node identifier assigned to the parent node of the slave-side specific node is stored, said node identifier assigned to the parent node being associated to the node identifier assigned to the slave-side specific node, and values larger than or equal to a value of the node identifier assigned to the slave-side specific node is stored in the contiguous area; and
inserting the descendant nodes of the slave-side specific node into the master-side data, wherein the descendant nodes are regarded as descendant nodes of a master-side specific node in the master-side data, which corresponds to the slave-side specific node.

18. The node insertion method as claimed in claim 17, wherein the step of inserting the descendant nodes of the slave-side specific node into the master-side data includes the steps of:
creating an array representing a new parent-child relationship, wherein the created array consists of a first array representing the parent-child relationship between the nodes in the master-side data and a second array representing the parent-child relationship concerning the descendant nodes of the slave-side node in the slave-side data and being inserted into the first array, by
assigning the node identifiers to the nodes in the master-side data and to the descendant nodes of the slave-side specific node in the slave-side node, wherein the node identifiers are assigned according to an order, in which the descendant nodes of the slave-side specific node are inserted at the descendant nodes of the master-side specific node and each child node of a node of interest is assigned the node identifier before each node in the same generation as the node of interest is assigned the node identifier, and
associating the node identifiers assigned to the nodes with the node identifiers assigned to parent nodes of the respective nodes in order thereof.

19. The node insertion method as claimed in claim 18, wherein the step of creating the array representing the new parent-child relationship includes the steps of:
assigning the node identifiers to the respective nodes in the master-side data according to an order, in which each child node of a node of interest is assigned the node identifier before each node in the same generation as the node of interest is assigned the node identifier, until a master-side specific node appears, and associating the node identifiers assigned to the respective nodes in the master-side data with the node identifiers assigned to parent nodes of the respective nodes in the master-side data;
assigning the node identifier to the master-side specific node, assigning the node identifiers to the descendant nodes of the slave-side specific node according to an order, in which each child node of a node of interest is assigned the node identifier before each node in the same generation as the node of interest is assigned the node identifier, such that the descendant nodes of the slave-side specific node are regarded as descendant nodes of the master-side specific node, and associating the node identifiers assigned to the descendant nodes with the node identifiers assigned to the parent nodes of the respective descendant nodes; and
assigning the node identifiers to remaining nodes in the master-side data according to an order, in which each child node of a node of interest is assigned the node identifier before each node in the same generation as the node of interest is assigned the node identifier, and associating the node identifiers assigned to the remaining nodes with the node identifiers assigned to the parent nodes of the respective remaining nodes, if the remaining nodes exist in the master-side data.

20. An information processing apparatus comprising a storage device for storing a master-side data and a slave-side data in the form of a tree data structure therein, wherein in each of the master-side data and the slave-side data stored in the storage device,
nodes, including a root node, are assigned unique node identifiers, which are sequential integers that are assigned to the nodes such that each child node of a node of interest is assigned the integer before each node in the same generation as the node of interest is assigned the integer,
the node identifiers assigned to non-root nodes, which are nodes other than the root node, are associated with the node identifiers assigned to parent nodes of the respective non-root nodes, and
a parent-child relationship between the nodes is represented by an array containing the node identifiers assigned to the parent nodes of the respective non-root nodes, said node identifiers assigned to the parent nodes being associated to the node identifiers assigned to the non-root nodes in order of the node identifiers assigned to the non-root nodes, characterized in that the information processing apparatus comprises:
a descendant node identification means for identifying all descendant nodes of the slave-side specific node by extracting a contiguous area from the array representing the parent-child relationship in the slave-side data, wherein the contiguous area starts at a location following the location where the node identifier assigned to the parent node of the slave-side specific node is stored, said node identifier assigned to the parent node being associated to the node identifier assigned to the slave-side specific node, and values larger than or equal to a value of the node identifier assigned to the slave-side specific node is stored in the contiguous area; and
a node insertion means for inserting the descendant nodes of the slave-side specific node into the master-side data, and storing information representing a new parent-child relationship in the storage means, wherein the descendant nodes are regarded as descendant nodes of a master-side specific node in the master-side data, which corresponds to the slave-side specific node.

21. The information processing apparatus as claimed in claim 20 wherein the node insertion means creates an array representing a new parent-child relationship, in which the created array consists of a first array representing the parent-child relationship between the nodes in the master-side data and a second array representing the parent-child relationship concerning the descendant nodes of the slave-side node in the slave-side data and being inserted into the first array, by
assigning the node identifiers to the nodes in the master-side data and to the descendant nodes of the slave-side specific node in the slave-side node, wherein the node identifiers are assigned according to an order, in which the descendant nodes of the slave-side specific node are inserted at the descendant nodes of the master-side specific node and each child node of a node of interest is assigned the node identifier before each node in the same generation as the node of interest is assigned the node identifier, and
associating the node identifiers assigned to the nodes with the node identifiers assigned to parent nodes of the respective nodes in order thereof.

22. The information processing apparatus as claimed in claim 21, wherein the node insertion means comprises:
a means for determining whether the node in the master-side data is the master-side specific node;
a means for assigning the node identifier to the node in the master-side data according to an order, in which each child node of a node of interest is assigned the node identifier before each node in the same generation as the node of interest is assigned the node identifier, and associating the node identifier assigned to the node in the master-side data with the node identifier assigned to a parent node of the node in the master-side data, if the node in the master-side data is not the master-side specific node; and
a means for assigning the node identifier to the master-side specific node, assigning the node identifiers to the descendant nodes of the slave-side specific node according to an order, in which each child node of a node of interest is assigned the node identifier before each node in the same generation as the node of interest is assigned the node identifier, such that the descendant nodes of the slave-side specific node are regarded as descendant nodes of the master-side specific node, and associating the node identifiers assigned to the descendant nodes with the node identifiers assigned to the parent nodes of the respective descendant nodes, if the node in the master-side data is the master-side specific node.

23. A program executed in a computer comprising a storage device for storing a master-side data and a slave-side data in the form of a tree data structure therein, wherein in each of the master-side data and the slave-side data stored in the storage device,
nodes, including a root node, are assigned unique node identifiers, which are sequential integers that are assigned to the nodes such that each child node of a node of interest is assigned the integer before each node in the same generation as the node of interest is assigned the integer,
the node identifiers assigned to non-root nodes, which are nodes other than the root node, are associated with the node identifiers assigned to parent nodes of the respective non-root nodes, and
a parent-child relationship between the nodes is represented by an array containing the node identifiers assigned to the parent nodes of the respective non-root nodes, said node identifiers assigned to the parent nodes being associated to the node identifiers assigned to the non-root nodes in order of the node identifiers assigned to the non-root nodes, characterized in that the program causes the computer to perform the functions of:
identifying all descendant nodes of the slave-side specific node by extracting a contiguous area from the array representing the parent-child relationship in the slave-side data, wherein the contiguous area starts at a location following the location where the node identifier assigned to the parent node of the slave-side specific node is stored, said node identifier assigned to the parent node being associated to the node identifier assigned to the slave-side specific node, and values larger than or equal to a value of the node identifier assigned to the slave-side specific node is stored in the contiguous area; and
inserting the descendant nodes of the slave-side specific node into the master-side data, and storing information representing a new parent-child relationship in the storage means, wherein the descendant nodes are regarded as descendant nodes of a master-side specific node in the master-side data, which corresponds to the slave-side specific node.

24. The program as claimed in claim 23, wherein the function of storing the information representing the new parent-child relationship includes the function of creating an array representing a new parent-child relationship, in which the created array consists of a first array representing the parent-child relationship between the nodes in the master-side data and a second array representing the parent-child relationship concerning the descendant nodes of the slave-side node in the slave-side data and being inserted into the first array, by
assigning the node identifiers to the nodes in the master-side data and to the descendant nodes of the slave-side specific node in the slave-side node, wherein the node identifiers are assigned according to an order, in which the descendant nodes of the slave-side specific node are inserted at the descendant nodes of the master-side specific node and each child node of a node of interest is assigned the node identifier before each node in the same generation as the node of interest is assigned the node identifier, and
associating the node identifiers assigned to the nodes with the node identifiers assigned to parent nodes of the respective nodes in order thereof.

25. The program as claimed in claim 24, wherein the function of creating the array representing the new parent-child relationship includes the functions of:
determining whether the node in the master-side data is the master-side specific node;
assigning the node identifier to the node in the master-side data according to an order, in which each child node of a node of interest is assigned the node identifier before each node in the same generation as the node of interest is assigned the node identifier, and associating the node identifier assigned to the node in the master-side data with the node identifier assigned to a parent node of the node in the master-side data, if the node in the master-side data is not the master-side specific node; and
assigning the node identifier to the master-side specific node, assigning the node identifiers to the descendant nodes of the slave-side specific node according to an order, in which each child node of a node of interest is assigned the node identifier before each node in the same generation as the node of interest is assigned the node identifier, such that the descendant nodes of the slave-side specific node are regarded as descendant nodes of the master-side specific node, and associating the node identifiers assigned to the descendant nodes with the node identifiers assigned to the parent nodes of the respective descendant nodes, if the node in the master-side data is the master-side specific node.

26. A computer readable recording medium having a program as claimed in claim 23 stored thereon.

27. A computer readable recording medium having a program as claimed in claim 24 stored thereon.

28. A computer readable recording medium having a program as claimed in claim 25 stored thereon.
